(19) United States
(12) Patent Application Publication
(10) Pub. No.: US 2008/0065507 A1
(43) Pub. Date: Mar. 13, 2008

(54) Interactive digital media services

(76) Inventors: James Morrison, Duluth, GA (US); Jeremy S. de Bonet, North Andover, ME (US); Scott Hughes, Suwanee, GA (US)

Correspondence Address: SIDLEY AUSTIN LLP, 555 CALIFORNIA STREET, SUITE 2000, SAN FRANCISCO, CA, 94104-1715, US

(21) Appl. No.: 11/705,948

(22) Filed: Feb. 12, 2007

Related U.S. Application Data
(63) Continuation-in-part of application No. 11/520,488, filed on Sep. 12, 2006.

(51) Int. Cl. G06Q 30/00

(52) U.S. Cl. 705/26; 705/27

(57) ABSTRACT

Methods, systems, and apparatus, including computer software, for interactive digital media service is presented. A content provider streams secondary content, such as images, chat-room discussions, offers for sale, promotions, advertisements, contests, or surveys, along with primary media content, such as radio or television programs, to multiple consumer devices. The consumer can interact with the content provider by sending messages in real time, and the content provider can edit or modify the primary media content or secondary content based on the received messages. The consumer can also order commercial transactions, such as buy products offered for sale, download digital content, songs, ring-tones, and screensavers. An operator of the system can manage and control the primary and secondary content and modify them in real time according to the consumer interaction. The content provider can also build a consumer data base based on the consumers' communications. Various business models are described as well.

### CROSS REFERENCE TO A RELATED APPLICATION

The present application is a continuation-in-part of, and claims the benefit of priority from co-pending U.S. patent application Ser. No. 11/520,488, filed on Sep. 12, 2006, entitled “Interactive Digital Media Services,” the entirety of which is incorporated by reference herein.

### BACKGROUND

The present invention relates to digital media programs, more precisely to interactive digital media services.

Digital media programs are audio, video or multimedia programs in digital format. For example, digital media programs can include digital radio or television programs. The digital media programs can be streamed to multiple consumers, for example, by radio or television stations, from satellites, through cable or a telephony network (e.g., Digital Subscriber Line (DSL)), over the Internet, or by any other suitable means. More recently, digital media programs, such as digital radio or television programs, are streamed to consumers over wireless or cellular networks. For example in a network that uses information packets, the digital media programs can be streamed to the consumer devices using broadcast, multicast, or unicast packets.

The streamed media programs can be received by consumer devices configured to receive and process the digital media content. For example, digital radio programs can be received by specially designed digital radio receivers or other digital devices such as desktop computers or portable digital devices, such as laptop computers and handheld devices, for example, cell phones, smartphones, pocket PCs, palmtops, or personal digital assistants (PDAs).

The digital media programs are typically organized into one or more program channels, where each program channel represents a separate, real-time stream of media content. The digital media programs are provided for each program channel by one or more respective media content providers. For example, a radio content provider often generates radio programs by recording audio content at a particular location, typically in a studio. The recorded audio content can be streamed to the consumers “live,” i.e., without substantial delay, or at a later time that would allow editing the audio content. For example, a typical radio program often includes a collection of pre-recorded music or audio advertisements interrupted with live content, such as interviews, comments and announcements presented by a DJ. In most cases, the flow of the service is one way: the listeners or consumers only receive the program, but cannot interact with the content provider.

In those cases where some interaction is possible, the radio listener can use only communication channels that are separate and different from the one through which the radio program is received. For example, the radio listener can telephone the DJ, or use traditional or electronic mail. Similar to radio programs, live television programs typically allow consumers to interact with a program host by telephone or traditional or electronic mail. Thus, the interaction is often slow and unorganized, and consequently, the content provider rarely modifies the radio or television content in response to the consumer communication. In some systems, a mobile device includes a “good old FM radio” to receive traditional analog radio broadcast through the air, and the mobile device is also capable to use a digital network to send messages to the radio station or receive visual information related to current FM radio programs. Thus, similar to the other traditional systems, the information exchange about the radio program happens through a communication channel that is separate and different from the one through which the radio program is received.

### SUMMARY

Briefly and generally, embodiments of the present invention provide an interactive digital media service, which allows a media content provider to select and stream secondary content, such as studio shots, images, commercial offers, promotions, advertisements, or surveys, along with primary media content through a communication network to multiple consumer devices. The consumer devices can be configured to present both the primary media content and the secondary content, including commercial components such as offers for sale, promotions, direct response advertisements, contests, or surveys. The consumer can use the same communication network to interact with the content provider by sending messages to the media content provider in real time, for example, in response to the secondary content or any other content. The content provider can edit or modify the primary media content or secondary content elements based on the received messages. The radio content provider can also build a consumer data base based on the consumers' interactive communications.

In general, in one aspect, the present invention provides methods, system, and apparatus, including computer software products, for providing a “visual” radio experience. Digital content is streamed to an audience comprising at least one consumer device, wherein the digital content includes primary media content and secondary content. Communication initiated at the consumer device is received, where the received communication relates to the primary media content or the secondary content. The communication is relayed to a media distributor or a content provider, whereby providing feedback for controllably selecting the primary media content or the secondary content.

Particular implementations can include one or more of the following features. The step of controllably selecting the secondary content can include presenting on a computer-controlled display a plurality of icons representing visual assets which are contextually related to the primary media content. A scheduler can be operated for preselectably and dynamically designating a series of the icons to be streamed to the audience. An on-air indicator can be provided on the display for identifying one of the icons as corresponding to a visual asset designated for current streaming to the audience. A selector can be provided to selectably alter the order of the icons in the series, or to add icons to or remove icons from the series. An editor can be provided for creating an icon representing a new visual asset and for editing an icon representing a pre-existing visual asset. A representation of text messages received from at least one member of the audience can be presented on the display. Thus, a visual radio experience can be controllably provided by allowing a plurality of visual assets or the textual representation to be selectably streamed to the audience in controllable correlation with the streaming of the primary media content. Offers to sell can be provided in at least one of the visual assets in the streamed assets. Surveys can be selectably included in the streamed assets. A text editor can be provided for editing a caption or price information for a visual asset to be streamed. At least one of the icons can correspond to a visual asset comprising a ring-tone, a digital wallpaper, an image, a video clip, downloadable digital data, or a game.

In general, in another aspect, the present invention provides methods, system, and apparatus, including computer software products, for providing an interactive content experience. Primary media content and secondary content are received. The primary media content is streamed to at least one mobile device. The secondary content is streamed to the same mobile device. The secondary content includes a series of visual assets controllably selected for streaming in temporal or contextual correlation with the primary media content. Interactive responses relating to at least one of the visual assets are received from the mobile device.

Particular implementations can include one or more of the following features. The series of visual assets can be altered by adding, removing, deleting, or changing the order of visual assets in the series. The primary media content can be altered in response to at least one of the interactive responses.

In general, in another aspect, the present invention provides methods, system, and apparatus, including computer software products, for providing an interactive visual radio experience. A streaming radio program is received at a programmable mobile device. A series of icons corresponding to visual assets is received at the mobile device, wherein the icons have been controllably selected for streaming. The icons are depicted on a display on the mobile device. Interactive capability is provided for a user of the mobile device. Thus, the mobile device provides both a radio program and visual assets concurrently with an interactive capability. The visual radio experience of some of these embodiments can be viewed as a smart mobilecasting system.

Particular implementations can include one or more of the following features. The radio program can include primary media content. The series of icons can include secondary content. Providing interactive capability can include one or more of providing a selector for initiating a request to buy a visual asset, providing text messaging capability for a user of the mobile device, providing a survey capable of being responded to by a user of said device, and providing a contest capable of being entered by a user of said device.

Particular embodiments can be implemented to realize one or more of the following advantages. The interactive streaming system can provide instant interaction using instant messaging (IM), comments or messages directed to the DJ, a studio guest, a talk show host, and other listeners. The interactive streaming system can deliver complete downloads, songs, ring-tones, games, screensavers, and any computer applications to the consumers. The consumer devices can receive secondary content elements and display such elements along with presenting the primary media content. The secondary content elements can be displayed, for example, using split screen applications. Thus, the consumer can view both a video and a dedicated IM chat-room related to a current program or another topical chat-room. Or, the consumer can view a video and an offer to sell, or a photo or a textual presentation and an offer to sell, or any other combination. The consumer device can also display a program front page, an image of the host, a photo of a guest, a video selected by the DJ or the host, an activity in the studio, advertisements, promotions, or media programming data, such as starting or remaining time, time of a next show, guest list, or upcoming topics. The consumer device can also display other program related data, such as sports statistics, or a portal to a music store or a mobile content or application store. The interactive streaming system also enables the consumer to buy and download entire songs, ring-tones, or screen savers and wallpapers. The system can also provide a portal to m-commerce services. The consumer can use convenient selectable icons, e.g., to buy an advertised item or to choose a previous show.

Furthermore, particular embodiments can provide all functionality from within one application. Thus, multiple functionalities can be converged. A consumer can interact with the content provider without exiting from currently running applications, such as a current Wireless Application Protocol (“WAP”) session. For example, a consumer can interact with a radio broadcast without opening a new application or WAP session. In such an integrated messaging application the consumer can send a text message without exiting the current session, then prompting a text session, then restarting the current application. To implement the interactive digital media service, the consumer devices can include corresponding computer software. The software can be pre-loaded in the device or downloaded at a later time by the consumer. For example, the consumer can download the software onto a mobile device over the air by sending a keyword to a short code, such as the call letters of their local station. Or the consumers can call an interactive voice response (“IVR”) number. The software can be sent to the consumer's mobile device through an SMS link. The interactive digital media service can be implemented to transmit different types of digital content or to invoke different digital data services. For example, the interactive digital media service can be implemented to transmit data using Voice over Internet Protocol (“VoIP”). Or, the interactive digital media service can implement a Push To Talk (“PTT”) system to connect with the content provider by leaving a verbal message. The interactive digital media service can also be implemented to use a peer-to-peer (“P2P”) functionality. For example, information exchange between a community of consumers can be directed by a content provider or a moderator live through a system that also prompts input from other sources, such as a Radio, TV or any other content providers. The interactive digital media service can be implemented to stream content originated from two or more content sources. The visual or other assets to be streamed can be managed by the content provider in real time. The content provider can use software applications that are configured to manage consumer interactions automatically, i.e., without a human operator's interaction. For example, the content provider can use software applications configured to respond or otherwise react to consumer responses or requests automatically. Thus, the content provider can utilize the functionality of automatic response during interactive media programming. This may allow a talk show host or a DJ to engage the audience, in particular during periods, such as late at night, when there would be little or no interaction. For example, the software application can present pre-programmed advertisements or music information based upon a preset playlist. The interactive digital media service can be accessed by Internet enabled devices. The consumer's device can be personalized by the consumer. Thus, the consumer can implement a unique feature. For example, the consumers can listen to their local stations while traveling. Or the consumers can follow international broadcasts. The interactive digital media service can be implemented to use location based services (“LBS”). Thus, some of the consumers can be selectively included or excluded from accessing a particular content portion. Or the system can provide content, such as targeted promotions or advertising that is particularly relevant to listeners in a particular geographic region. The consumer can also conduct commerce transactions or participate in promotions. The consumer can also create content and share the created content with the content provider, an advertiser or other community members using the interactive digital media service. The consumer created content can include text, SMS, images, video, Microsoft Media Services (MMS) or other media content. The consumer can share content without stopping the current application and restarting another application to invoke a different functionality, such as communication with other consumers, content providers or advertisers.

In some embodiments an interactive media service method includes providing partner services for a mobile-cast interactive media service; providing revenue generating services in relation to the interactive media service; and participating in a business model, including generating of the revenue and distributing of the revenue in relation to the interactive media service.

In embodiments the mobile-cast interactive media service includes streaming media content towards users of the service on media channels; and receiving interaction from the users over the same media channels.

In other embodiments the mobile-cast interactive media service includes streaming digital content directed to at least one mobile consumer device; wherein the digital content comprises primary media content and secondary content; receiving interactive communication initiated at the mobile consumer device, where the communication relates to the primary or secondary media content; and at least one of initiating a transaction, modifying the primary media content, and modifying the secondary content in relation to the received interactive communication.

In embodiments the method includes: providing a sale service by offering static or dynamic assets for sale in relation to the interactive media service; providing an advertisement service by mobile-casting an advertisement as a secondary media content in relation to a primary media content, providing a responsive service, including at least one of a survey, contest, polling, voting, betting, lottery, auction, and bidding; providing a community service, wherein the community service includes providing a moderated peer-to-peer community; providing a targeting service, wherein the targeting service includes recording and reporting at least one of a purchasing profile of users of the service, a purchasing patterns of the users, a geographic distribution of the users, and a typical time of purchasing by the users; and providing a tie-in service, wherein the tie-in service includes at least one of offering for sale an item in relation to previous activities of a user, and advertising products in relation to previous purchases of a user.

In embodiments the revenue generating services include on-deck and off-deck services.

In embodiments the providing the partner services includes providing source partner services; providing provider partner services; providing carrier partner services; providing service partner services for the interactive media services, including at least one of actively facilitating the interactive media service and providing a system for others to facilitate the interactive media service; and providing business partner services.

Embodiments include participating in a business model, with a revenue generation including a subscriber model, a sponsor model, an advertiser model, and a revenue sharing model.

Embodiments include generating revenue according to a metric of the interactive media service. The metric can include a time metric, a usage metric, an event metric and a revenue metric.

### BRIEF DESCRIPTION OF THE DRAWINGS

FIGS. 1A-2B are schematic block diagrams illustrating interactive digital media streaming systems.

FIGS. 3 and 4 are schematic block diagrams illustrating secondary content elements and commercial servers, respectively, for interactive digital media streaming systems.

FIGS. 5-7 are schematic flow charts illustrating methods for interactive digital media streaming systems.

FIGS. 8A and 8B illustrate exemplary screen shots generated by user interfaces for interactive digital media streaming systems.

FIG. 9 is a schematic flow chart illustrating interactive operation of a media provider.

FIG. 10 is a schematic flow chart illustrating interactive operation of a consumer interaction service provider.

FIG. 11 is a schematic flow chart illustrating interactive operation of a communication network.

FIG. 12 is a schematic flow chart illustrating interactive operation of a consumer device.

FIGS. 13A-E illustrate exemplary screen shots related to interactive operation of consumer devices.

FIG. 14 is a schematic flow chart illustrating commercial operation of a content provider.

FIG. 15 is a schematic flow chart illustrating commercial operation of a media provider.

FIG. 16 is a schematic flow chart illustrating commercial operation of a consumer interaction service provider.

FIG. 17 is a schematic flow chart illustrating commercial operation of a communication network.

FIG. 18 is a schematic flow chart illustrating commercial operation of a consumer device.

FIG. 19 is a schematic flow chart illustrating commercial operation of a consumer device.

FIGS. 20A-C illustrate exemplary screen shots related to commercial operation of consumer devices.

### DETAILED DESCRIPTION

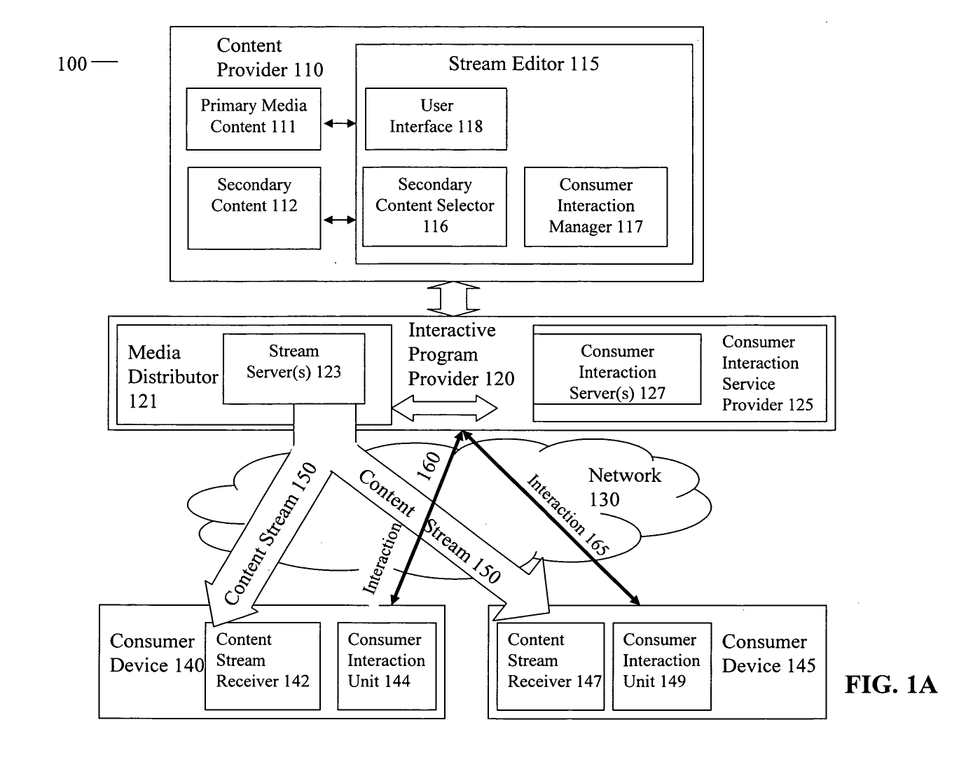

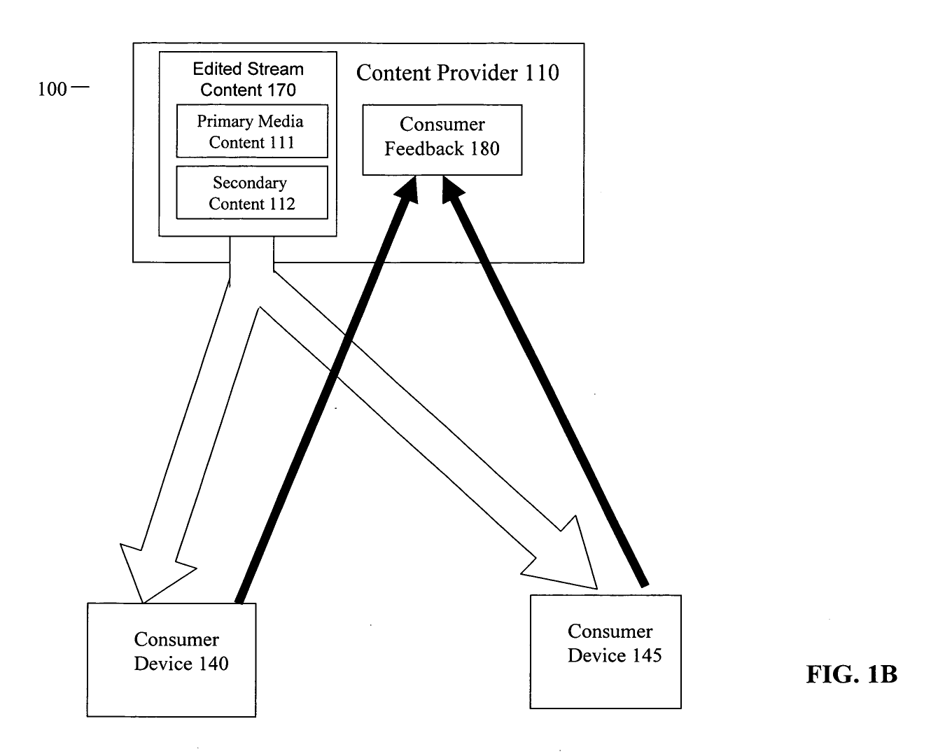

FIG. 1A illustrates an interactive digital media streaming system 100 according to one aspect of the present invention. The interactive media streaming system 100 can be used to stream digital media content along with additional content to multiple consumers and allow the consumers to respond to the received content in real time. In one implementation, the system 100 is used to stream digital radio or television programs to multiple consumers, where the consumers can respond to commercial elements in the received content or interact with each other or a live operator of the currently streamed television or radio program. Alternatively, the system 100 can be used to stream any other media content to multiple consumers and allow the consumers to interact with each other, an operator of the current content stream, or other parties related to the streamed content.

The interactive media streaming system 100 includes a content provider 110, an interactive program provider 120, a communication network 130, and an audience including multiple consumers with their respective devices, such as consumer devices 140 and 145. The content provider 110 provides content to the interactive program provider 120, which forms a content stream 150 from the received content and streams the content stream 150 through the communication network 130 to the consumer devices 140 and 145. The consumer devices 140 and 145 receive the streamed content and present it to their respective users, i.e., the consumers. The consumers can use their respective consumer devices 140 and 145 to interact with the interactive program provider 120 or the content provider 110 in response to the received content. For example, the consumer devices 140 and 145 can establish respective interactions 160 and 165 to send information through the network 130 back to the interactive program provider 120. The interactive program provider 120 can process the information received from the consumers and transmit the processed information to the content provider 110, or to one or more other service providers (not shown).

The content provider 110 provides primary media content 111 and secondary content 112 and includes a stream editor 115 to review and edit the primary media content 11 and the secondary content 112 for streaming by the interactive program provider 120. The primary media content 111 includes media programs of primary interest that are streamed to the consumer devices 140 and 145 and presented to their respective users. The secondary content 112 is streamed along with the primary media content 112, and includes content to be presented to the consumers in addition to the primary media content 111. For example, the primary media content 111 can include radio or television programs, and the secondary content 112 can include text, images or videos to be displayed while the consumer listens to a radio program or watches a television program.

The primary media content 111 can be organized into one or more program channels, where each program channel represents a separate flow of media content. For each program channel, the primary media content 111 can include prestored media content, such as images, music or other audio recordings, videos, movies, pre-recorded television or radio shows. The primary media content 111 can also be generated “live” by the content provider 110. For example, the content provider 110 can record video or audio programs in a studio and transmit the recorded material to the consumers without substantial delay.

In one implementation, the primary content 111 includes video content, such as television programs or any other video programs. For example, the primary content 111 can include a live video program, a pre-recorded video program, a TV program, a webcast, a podcast, or any equivalents. The video content can be formatted or compressed using any suitable format or techniques, such as those provided by Audio Video Interleave (AVI), Windows Media, MPEG4, Quicktime, Real Video, or Shockwave/Flash format, or any equivalent techniques.

The secondary content 112 includes content elements that can be presented along with the primary media content 111. For example, the secondary content 112 can include text elements, image elements, or small video elements that can be presented “on the side” while the consumer also watches or listens to the primary media content 111. The secondary content 112 can include pre-stored elements, such as graphics, animations, photographs or video clips. The secondary content 112 can also include elements generated “live” by the content provider 110. For example, the content provider 110 can take live snap shots in the studio, or generate text or graphical representation of live consumer interaction, such as live consumer messages or results of live consumer surveys or contests.

The stream editor 115 includes a secondary content selector 116, a consumer interaction manager 117, and a user interface 118. The secondary content selector 116 selects elements of the secondary content 112 to be streamed along with the primary content 111, and the consumer interaction manager 117 manages interaction with the consumer devices 140 and 145. The user interface 118 allows an operator to monitor and edit content to be streamed, and to manage the secondary content selector 116 and the consumer interaction manager 117.

The secondary content selector 116 can select and schedule elements of the secondary content 112 for streaming to consumers. The secondary content elements can be selected or scheduled automatically according to a predetermined schedule or predetermined rules. For example, the secondary content selector 116 can include an artificial intelligence device to pre-sort and pre-schedule elements of the secondary content 112 into a streaming schedule. The secondary content selector 116 can also select elements of the secondary content 112 for streaming based on user input received from the user interface 118. Based on the received user input, the secondary content selector 116 can also delete, alter or reschedule elements of the secondary content 112 for streaming. Thus, the operator can use the secondary content selector 116 to control the selection and timing of the secondary content elements that are streamed along with the primary media content 111.

In one implementation, the content provider 110 can also use time shifting for streaming the primary content 111 or the secondary content 112. For example, one or more media programs can be recorded and the recorded media programs can be placed in a linear loop that plays over and over until the next live show begins. Thus, the consumers can access the programs streamed in the loop as they are being played back. That is, the streamed programs cans be accessed at the point that is currently streamed, depending on the current timing of the streamed loop. Alternatively, the recorded media programs can be streamed on the consumers' demand (commonly referred to as “on demand” service) starting from the beginning and playing to the end of the recorded program or programs.

The consumer interaction manager 117 receives information communicated by the consumer devices 140 and 145 while content is streamed to those devices. For example, the consumer interaction manager 117 can receive text messages, survey and contest responses, or other consumer communications related to the currently streamed primary media content 111 or secondary content 112. The consumer interaction manager 117 can also process the received consumer information. For example, the interaction manager 117 can format the received consumer information for presentation in the user interface 118 or as an element of the secondary content 112. Or the interaction manager 117 can parse consumer messages and select or rank them based on the level of their relevance. Optionally, the consumer interaction manager 117 can also receive and process consumers' responses to commercial elements, such as offers for sale, advertisements or promotions that have been streamed to the consumer devices 140 and 145 as secondary content elements along with the primary media content 111.

In one implementation, the interaction manager 117 can also evaluate the received consumer information and record results of the evaluation. Thus, the consumer interaction manager 117 can determine and record one or more features of the received consumer communications. The determined and recorded features can include survey or contest results, individual or overall responses to advertisements or promotions, or other statistical features of the consumer communications. The consumer interaction manager 117 can also manage and update a consumer data base based upon the received consumer communications. In alternative implementations, one or more functions of the consumer information manager 117 can be performed, at least in part, by the interactive program provider 120.

The user interface 118 displays information received from the secondary content selector 116 and the consumer interaction manager 117. The user interface 118 can also receive user input from an operator of the stream editor 115 to control the secondary content selector 116 and the consumer interaction manager 117. The user interface 118 can also display information related to the primary media content 111 or the secondary content 112. Thus, the user interface 118 allows the operator to monitor and edit content to be streamed to the consumer devices 140 and 145. The same or a different operator can also use the user interface 118 to control the consumer interaction manager 117 in order to manage consumer communication while the content is streamed.

The interactive program provider 120 includes a media distributor 121 and a consumer interaction service provider 125. The media distributor 121 streams the content stream 150 through the communication network 130 to the consumer devices 140 and 145, and the consumer interaction service provider 125 processes communications received through the network 130 from the consumer devices 140 and 145 in response to the content stream 150. The media distributor 121 and the consumer interaction service provider 125 can share or exchange information. Thus, the media distributor 121 can receive consumer information from the consumer interaction service provider 125, and the consumer interaction service provider 125 can receive information about the content stream 150.

The media distributor 121 receives the primary media content 111 and the secondary content 112 from the content provider 110. The media distributor 121 includes a stream server 123 that composes the content stream 150 from the received content. Thus, the stream server 123 streams the primary media content 111 and the secondary content 112 through the communication network 130 to the consumer devices 140 and 145.

Optionally, the media distributor 121 can also receive communications from the consumer devices 140 and 145, and forward the received communications to the consumer interaction service provider 125. Or the media distributor 121 can receive information from the consumer interaction service provider 125, and forward the received information to the consumer devices 140 and 145 or to the content provider 110.

The consumer interaction service provider 125 receives and replies to communications initiated at the consumer devices 140 and 145. The consumer interaction provider 125 can also record, process, or forward the consumer communications. For example, the consumer interaction service provider 125 can determine and record one or more features of the received consumer communications. The determined and recorded features can include survey or contest results, individual or overall responses to advertisements or promotions, or other statistical features of the consumer communications. The consumer interaction service provider 125 can also manage and update a consumer data base based upon the received consumer communications. Optionally, the consumer interaction service provider 125 can forward the original or the fully or partially processed consumer communications to the media distributor 121, the consumer interaction manager 117, or any other service providers (such as order fulfillment services, not shown).

The consumer interaction service provider 125 includes one or more consumer interaction servers 127 to process and forward incoming consumer communications and to generate appropriate responses to the consumer devices 140 and 145. For example, the consumer interaction servers 127 can record, sort, or redirect the incoming user communications. The consumer interaction servers 127 can also respond to the received consumer communications, for example, by sending acknowledgments to or requesting information for commercial or financial transactions from the consumer devices 140 and 145. The consumer interaction servers 127 can also include digital publication servers that can receive orders for digital content from the consumer devices 140 and 145, and transmit the ordered content to the consumer devices 140 and 145.

The communication network 130 transmits the content stream 150 to the consumer devices 140 and 145 and establishes, at least in part, the interactions 160 and 165 between the interactive program provider 120 and the respective consumer devices 140 and 145. For each of the consumer devices 140 and 145, the communication network 130 can use the same or different communication channels for transmitting the content stream 150 and establish the respective interaction 160 or 165. The communication network 130 can use any appropriate protocol to transmit the content stream 150 or the consumer communications.

In one implementation, the communication network 130 is configured to transmit the content stream 150 to a large number of consumer devices, including the consumer devices 140 and 145. For example, the communication network can include one or more public or private, wired or wireless networks that cover many consumer devices or a large geographical area. Thus, the communication network 130 can include, at least in part, the Internet, wide area networks (WANs) or local area networks (LANs), cable networks, wired or wireless telephone networks. The communication network 130 can transmit the content stream 150 using broadcast, multicast or unicast information packets directed to each of the consumer devices 140 and 145. For example, the content stream 150 can be transmitted with podcasting.

The consumer devices 140 and 145 are digital devices configured to receive the content stream 150 and to communicate through the communication network 130. For example, the consumer devices 140 and 145 can include non-portable or portable digital radio or television devices, desktop computers, or portable digital devices, such as laptop computers and handheld devices, for example, cell phones, smartphones, palmtops, or personal digital assistants (PDAs).

The consumer devices 140 and 145 include content stream receivers 142 and 147, and consumer interaction units 144 and 149, respectively. Each of the content stream receivers 142 and 147 is configured to receive and present the user with the primary media content 111 in the content stream 150. For example, if the content stream includes a digital radio or television stream, the content stream receivers 142 and 147 include respective digital radio or television receivers. The content stream receivers 142 and 147 can also be configured to receive and present secondary content elements that are streamed along with primary media content 111 in the content stream 150.

The consumer interaction units 144 and 149 are configured to receive user input from the respective consumer and to transmit corresponding consumer communications to the content provider 110 or the interactive program provider 120 through the communication network 130. The consumer interaction units 144 and 149 can also be configured to receive and process communication, such as acknowledgements or requests for information from the content provider 110 or the interactive program provider 120.

The consumer interaction units 144 and 149 can use the same or different communication channel to transmit the consumer communications than the channel through which the content stream 150 is received. In one implementation, the consumer interaction units 144 and 149 can transmit the consumer communications or receive other communications without noticeable interruption in the reception of the content stream 150.

The consumer interaction units 144 and 149 can also be configured to receive, process and present secondary content elements that are streamed along with primary media content 111 in the content stream 150. For example, the secondary content elements can include offers for sale, surveys, contests or other information requesting consumer interaction, and the consumer interaction units 144 and 149 can process such information to generate corresponding user interface elements or, if the consumer has responded to a secondary content element, to generate and transmit appropriate communications to the content provider 110 or the interactive program provider 120.

The consumer devices 140 and 145 can interact with the interactive program provider 120 and the content provider 110 in an integrated manner. For example in integrated messaging implementations, the consumer can send a message without exiting the application running on the device, and subsequently sending a short code, sending the message, and then restarting the previously active application. Instead, the consumer can send the message (with or without a short code) while the original application remains active. Also, the content provider 110 can send live data from within a WAP session while still allowing for interactivity.

In some implementations, the consumer interactions utilize the Interactive Voice Response (UVR) technology. This technology enables interaction between a caller and a computer via the telephone. Callers can interact with IVR systems by pressing numbers on a telephone keypad or by speaking simple commands to answer the computer's voice prompts. Some embodiments use an IVR trigger to create a data session or download an application. This allows for another channel for content discovery or consumer selection. The response message from the IVR application can trigger some change or event from within the application. For example, a data session can be interrupted for a phone call and then resume seamlessly. Therefore, the integrated nature of some embodiments can allow a consumer to make a phone call to select an offered item or initiate another action while receiving a video in a content stream or engaging in a chat-room discussion.

The components in FIG. 1, and in all other Figures of the present application, can be realized, combined and grouped in a large number of ways. A functionality of one element may be performed by another element. Two elements may be combined or integrated into a single unit. For example, the content provider 110 and the media distributor 121 can be an integrated system. Or the consumer interaction server 127 and the consumer interaction manager 117 can be integrated into a single system. The functions of any one element can be performed by more than one physical unit, which can be separated by substantial physical distances. For example the stream servers 123 and the communication interaction servers 127 can be set up at distant locations, even though both are part of interactive program provider 120. The functions can be performed partially by software and partially by hardware and any combination of software and hardware.

FIG. 1B illustrates an implementation of information exchange in the interactive digital media streaming system 100, shown in FIG. 1A. In particular, FIG. 1B illustrates information exchange between the content provider 110 and the consumer devices 140 and 145.

The content provider 110 generates edited stream content 170. The edited stream content includes the primary media content 111 and the secondary content 112. For example, the content provider 110 can use the stream editor 115 (FIG. 1A) to generate the edited stream content 170.

The content provider 110 transmits the edited stream content 170 to the consumer devices 140 and 145. For example, the content provider 110 can provide the edited stream content 170 to the interactive program provider 120 (FIG. 1A) that generates the content stream 150 (FIG. 1A) from the edited stream content 170, and streams the content stream 150 (FIG. 1A) through the communication network 130 (FIG. 1A) to the consumer devices 140 and 145.

Each of the consumer devices 140 and 145 includes a respective tool, the consumer interaction unit 144 or 149 (FIG. 1A), that allows their respective user, i.e., the consumer, to send consumer feedback 180 to the content provider 110. The consumer feedback 180 can include direct consumer interactions or automatic reports generated by the consumer devices 140 and 145. For example, the consumers can respond to surveys, participate in contests, or compose and send comments about or in relation to the edited stream content 170 to the content provider 110. Or the consumer devices 140 and 145 can automatically report to the content provider 110 if the user has switched to another program channel.

In the system 100, the content provider 110 has an integrated tool, the stream editor 115 (FIG. 1A), which can present the consumer feedback 180 to one or more operators at the content provider 110, and allow these operators to change the edited stream content 170 in response to the consumer feedback 180. For example, one of the operators, such as a DJ in a radio studio, can respond to a consumer comment, and add both the consumer comment and his or her response to the edited stream content 170 as elements of the secondary content 112. Or, the operator can change the primary media content 111 in the edited stream content 170 if the consumer feedback 180 includes negative comments, or many consumers have switched to another program channel.

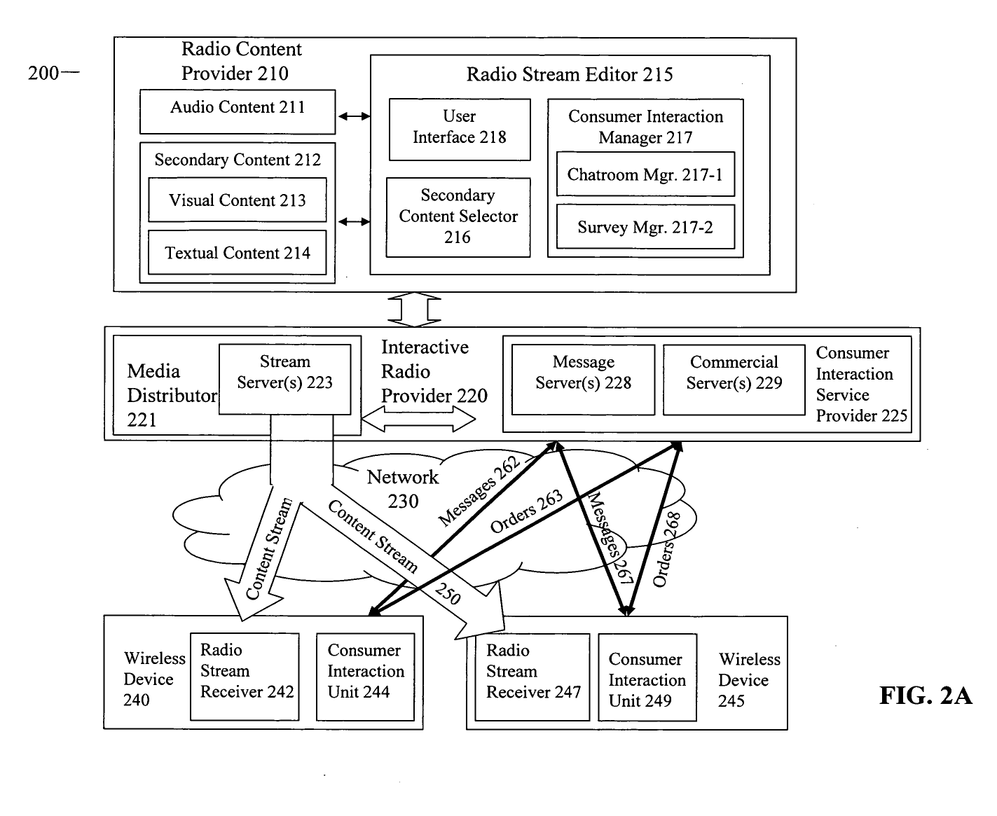

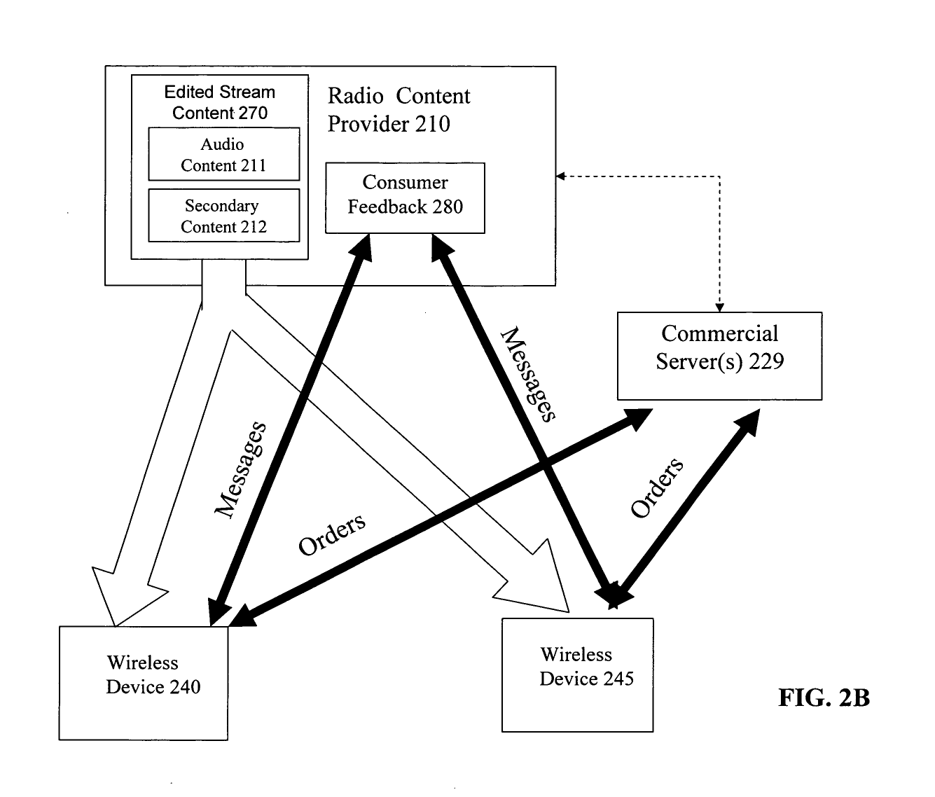

FIG. 2A illustrates an interactive digital radio streaming system 200 according to one aspect of the present invention. The interactive radio streaming system 200 can be implemented using the interactive digital media streaming system 100 (FIG. 1A). The interactive radio streaming system 200 is configured to stream digital audio content and additional content along with the audio content to multiple consumers, and to allow the consumers to respond to the received content in real time.

The interactive radio streaming system 200 includes a radio content provider 210, an interactive radio provider 220, a wireless communication network 230, and multiple consumer devices, such as wireless devices 240 and 245. The radio content provider 210 provides content to the interactive radio provider 220, which forms a content stream 250 from the received content and streams the content stream 250 through the wireless communication network 230 to the wireless devices 240 and 245. The wireless devices 240 and 245 receive the streamed content and present it to their respective users, i.e., the consumers. The consumers can also use their respective wireless devices 240 and 245 to interact with the interactive radio provider 220 and the radio content provider 210 in response to the received content. For example, the wireless devices 240 and 245 can establish respective interactions to communicate messages 262 and 267 and orders 263 and 268 through the wireless network 130 back to the interactive radio provider 220. The interactive radio provider 220 can process the information received from the consumers and transmit the processed information to the radio content provider 210, or to one or more other service providers (not shown).

The radio content provider 210 provides audio content 211 and secondary content 212 and includes a radio stream editor 215 to monitor the audio content 211 and to edit the secondary content 212 for streaming along with the audio content 211. The radio stream editor 215 can also be configured to review or edit the audio content 211, which includes radio programs for one or more program channels.

The audio content 211 can include music records, pre-recorded radio shows or advertisements. The audio content 211 can also be generated “live” using the radio content provider 210. For example, radio content provider 210 can include a radio station or a production unit of a radio personality, and the audio content 211 can include a radio talk show or music program produced by the radio station or the production unit. The radio talk show or music program can be streamed “live” or recorded for later streaming.

The secondary content 212 includes content elements that can be displayed using the wireless devices 240 and 245 while their respective consumers listen to the audio content 211. In one implementation, the secondary content 212 includes visual content 213 and textual content 214. The visual content 213 can include images, graphics, animations, or videos, and the textual content 214 can include text messages from consumers or from a DJ, announcements, advertisements, or other information in textual form.

For a radio show, the visual content 213 can include an image or a “lite video” representing a guest of the radio show. Lite video is a video of short duration (e.g. 15 sec), with reduced resolution or lower refresh rate. The lite video can be encoded using M-JPEG, MPEG, MPEG4, or any mobile compliant video format, such as those developed by the 3rd Generation Partnership Project (3GPP).

The lite video can include a video clip of the guest, or shots about the activity in the studio. The visual content 213 can also include still pictures of the guest or the studio activity. Or the visual content 213 can include images, graphics or animation to initiate a survey or contest or to represent the results of such surveys and contests. The images can have any recognized format, such as JPEG, PNG, TIFF, GIF, PCD, EPS, WMF, or bitmap formats. By streaming such visual content elements along with the audio content 211, the visual content 213 can enhance the consumer's experience during the talk show, making it more attractive to the listeners. If elements of the visual content 213 are streamed along with the audio content 211, the interactive radio system 200 may provide a “Smart Mobile Casting” experience.

For the radio show, the textual content 214 can include text messages, such as Instant Messages (IM) or Short Message Service (SMS) messages, received from the users of the wireless devices 240 and 245. A host of the radio show can also add text messages to the textual content 214. For example, the host can make announcements or respond to or comment on the consumers' messages. The textual content can also initiate a survey or contest or to represent the results of such surveys and contests. Thus, a true interaction can be initiated and facilitated between the consumers and the talk show host.

The secondary content 212 can also include commercial elements (also called commercial components), both in the form of the visual content 213 or the textual content 214. For example, the secondary content can include advertisements, promotions and offers for sale. Such commercial elements can be streamed along with the audio content 211 to increase the probability that the consumers would respond. For example, an artist's image, ring-tone, or video can be offered for sale in the secondary content 212 that is streamed along with the audio content 211 playing that artist's music.

The radio stream editor 215 includes a secondary content selector 216, a consumer interaction manager 217, and a user interface 218. The secondary content selector 216 selects elements of the secondary content 212 to be streamed along with the audio content 211, and the consumer interaction manager 217 manages interaction with the wireless devices 240 and 245. The user interface 218 allows an operator to monitor and edit content to be streamed, and to manage the secondary content selector 216 and the consumer interaction manager 217.

The secondary content selector 216 can select elements of the secondary content 212 based on user input received from the user interface 218, or automatically according to a predetermined schedule or predetermined rules. Thus, the operator can use the secondary content selector 216 to control the selection and timing of the secondary content elements that are streamed along with the audio content 211.

The consumer interaction manager 217 receives information communicated by the wireless devices 240 and 245 while receiving the content stream 250. The consumer interaction manager 217 includes a chat-room manager 217-1 and a survey manager 217-2. The chat-room manager 217-1 receives and processes text messages received from the wireless devices 240 and 245. For example, the chat-room manager 217-1 can format the received consumer information for presentation in the user interface 218. Or the chat-room manager 217-1 can parse consumer messages and select or rank the interesting ones for display by the user interface 218. In one implementation, the chat-room manager 217-1 is configured to provide elements of the secondary textual content 214.

The survey manager 217-2 manages interactions related to contest responses or surveys, such as consumer votes. Optionally, the survey manager 217-2 can also receive and process consumers' responses to commercial elements, such as offers for sale, advertisements or promotions that have been streamed as secondary content elements along with the audio content 211. In one implementation, the survey manager 217-2 determines and records survey or contest results, individual or overall responses to advertisements or promotions, or other statistical features. The survey manager 217-2 can also format the survey results as elements for streaming in the secondary content 212 or for presentation by the user interface 218.

The user interface 218 displays information received from the secondary content selector 216 and the consumer interaction manager 217, and receives user input from an operator of the radio stream editor 215 to control the secondary content selector 216 and the consumer interaction manager 217.

The interactive radio provider 220 includes a media distributor 221 and a consumer interaction service provider 225. The media distributor 221 streams the content stream 250 through the wireless communication network 230 to the wireless devices 240 and 245, and the consumer interaction service provider 225 processes the messages 262 and 267 and orders 263 and 268 received through the wireless network 230 from the wireless devices 240 and 245. The media distributor 221 and the consumer interaction service provider 225 can share or exchange information.

The media distributor 221 receives the audio content 211 and the secondary content 212 from the radio content provider 210. The media distributor 221 includes a stream server 223 that composes the content stream 250 from the received content. For example, the audio content 211 can be streamed using an audio codec, such as QCELP, AMR, MP3, AAC, AC3, or equivalents that are supported by the wireless devices 240 and 245. Thus, the stream server 223 streams the audio content 211 and the secondary content 212 through the wireless communication network 230 to the wireless devices 240 and 245.

The consumer interaction service provider 225 receives and replies to the messages 262 and 267 and orders 263 and 268 initiated at the wireless devices 240 and 245. The consumer interaction provider 225 can also record, process, or forward the messages 262 and 267 and orders 263 and 268. The consumer interaction service provider 225 includes one or more message servers 228 and one or more commercial servers 229. The message servers 228 process and forward the messages 262 and 267 and, if necessary, generate appropriate responses to the wireless devices 240 and 245. For example, the message servers 228 can record, sort, or redirect the messages 262 and 267. The message servers 227 can also send responses to the messages 262 and 267, for example, by sending acknowledgments or text messages addressed to individual consumer devices.

The commercial servers 229 can receive, process, and respond to the orders 263 and 268 that are commerce related communications received from the wireless devices 240 and 245. For example, the orders 263 and 268 can include orders to buy digital content or other goods in response to secondary content 212 streamed along with the audio content 211. The commercial servers 229 can process the orders 263 and 268 and, if required, request financial transaction or other information from the wireless devices 240 and 245. The commercial servers 229 can also include one or more digital publication servers that can transmit the ordered digital content to the consumer devices 240 and 245 through the wireless network 230. Optionally, the commercial servers 229 can also contact order-fulfillment or other servers (not shown) to complete transaction required to fulfill the orders 263 and 268.

The wireless communication network 230 transmits the content stream 250 to the wireless devices 240 and 245, and the messages 262 and 267 and orders 263 and 268 to the interactive radio provider 220. For each of the wireless devices 240 and 245, the wireless communication network 230 can use the same or different communication channels to transmit the content stream 250 and the respective messages 262 or 267 and orders 263 or 268. For telephonic wireless devices having both voice and data channels, the data channels can be used by the content stream 250 and the messages 262 and 267 and orders 263 and 268. The wireless communication network 230 can include any wireless networks, such as WiMAX, WiFi, or cellular wireless networks, and can use any appropriate protocol to transmit the content stream 250 or the messages 262 and 267 and orders 263 and 268. For example, the content stream 250 or the messages 262 and 267 and orders 263 and 268 can be transmitted to mobile phones or PDAs using wireless application protocol (WAP). Furthermore, the wireless communication network 230 can be configured to transmit the content stream 250 to a large number of wireless devices, including the wireless devices 240 and 245, using broadcast, multicast or unicast data packets. The wireless communication network 230 can also be connected to other networks, such as the Internet, wide area networks (WANs) or local area networks (LANs), cable networks, or wired telecommunication networks. Such networks can also participate, at least in part, in the transmission of the content stream 250 or the messages 262 and 267 and orders 263 and 268.

The wireless devices 240 and 245 are wireless digital devices configured to receive the content stream 250 and to communicate through the wireless communication network 230. For example, the wireless devices 240 and 245 can include portable digital radio devices, laptop computers or handheld devices, such as palmtops, cell phones, smartphones, or personal digital assistants (PDAs).

The wireless devices 240 and 245 include radio stream receivers 242 and 247, and consumer interaction units 244 and 249, respectively. Each of the radio stream receivers 242 and 247 is configured to receive and play the audio content 211 in the content stream 250. The consumer interaction units 244 and 249 are configured to receive user input from the respective consumer and to transmit the corresponding messages 262 and 267 or orders 263 and 268 to the interactive radio provider 220 through the wireless communication network 230. The consumer interaction units 244 and 249 can also be configured to receive and process communication, such as acknowledgements or requests for information from the interactive radio provider 220. The consumer interaction units 244 and 249 can use the same or a different communication channel to transmit the messages 262 and 267 or orders 263 and 268 than the communication channel through which the content stream 250 is received. In one implementation, the consumer interaction units 244 and 249 can transmit the consumer communications or receive other communications without noticeable interruption in the reception of the content stream 250.

The consumer interaction units 244 and 249 can also be configured to receive and process secondary content elements that are streamed along with the audio content 211 in the content stream 250. For example, the secondary content elements can include elements of the visual or textual contents 213 and 214, offers for sale, surveys, contests or other information requesting consumer interaction, and the consumer interaction units 244 and 249 can process such information to generate corresponding user interface elements or, if a corresponding user input is received from the consumer, to generate and transmit the appropriate messages 262 and 267 or orders 263 and 268 to the interactive radio provider 220. For example, the interaction units 244 and 249 can include a display screen to display the received elements of the visual or textual contents 213 and 214. The interaction units 244 and 249 can also be configured to allow split-screen applications to present multiple elements of the received secondary content 212 on the same screen. Thus, elements can be displayed both from the visual and textual contents 213 and 214. For example, the screen can display a lite video and text messages from the chat-room, a lite video and offers to sell, a photo and offers to sell. The interaction units 244 and 249 can also be configured to generate one or more SMS or pSMS for voting, contests, or m-commerce sales.

FIG. 2B illustrates an implementation of information exchange in the interactive digital media streaming system 200, shown in FIG. 2A. In particular; FIG. 2B illustrates information exchange between the radio content provider 210, the commercial servers 229, and the wireless devices 240 and 245.

The radio content provider 210 generates edited stream content 270 that includes the audio content 211 and the secondary content 212. For example, the radio content provider 210 can use the stream editor 215 (FIG. 2A) to generate the edited stream content 270.

The radio content provider 210 transmits the edited stream content 270 to the wireless devices 240 and 245. For example, the radio content provider 210 can provide the edited stream content 270 to the interactive radio provider 220 (FIG. 2A) that generates the content stream 250 (FIG. 2A) from the edited stream content 270, and streams the content stream 250 (FIG. 2A) through the wireless communication network 230 (FIG. 2A) to the wireless devices 240 and 245.

Each of the wireless devices 240 and 245 includes a respective tool, the consumer interaction unit 244 or 249 (FIG. 2A), that allows their respective user, i.e., the respective consumer, to generate consumer feedback 280. The consumer feedback 280 can include messages sent by the consumers to the radio content provider 210 about or in relation to the edited stream content 270. The consumer feedback 280 can also include automatic reports generated by the wireless devices 240 and 245. For example, the wireless devices 240 and 245 can automatically report to the radio content provider 210 if the user has switched to another radio program channel.

In the system 200, the content provider 210 has a tool, the stream editor 215 (FIG. 2A), which can present the consumer feedback 280 to one or more operators at the radio content provider 210, and allow these operators to change the edited stream content 270 in response to the consumer feedback 280. For example, one of the operators can be a DJ in a radio studio, who can respond to a consumer comment, and add the consumer comment or the DJ's response to the edited stream content 270 as elements of the secondary content 212. Or, the DJ can change the audio content 211 in the edited stream content 270, for example, if the consumer feedback 280 includes negative comments from the consumers or a report indicates that many consumers have switched to another radio program channel.

In addition to sending consumer feedback messages to the radio content provider 210, the consumers can use their respective wireless devices 240 and 245 to send orders, including buying orders or other commerce related messages, to the commercial servers 229. The commercial servers 229 can receive, process, and respond to the received orders. Thus, the consumers can buy digital content or other goods in response to the secondary content 212 that has been streamed along with the audio content 211. The commercial servers 229 can also include one or more digital publication servers that can transmit the ordered digital content to the wireless devices 240 and 245 through the wireless network 230 (FIG. 2A). Optionally, the commercial servers 229 can also contact order-fulfillment or other servers to complete transactions that are required to fulfill the orders 263 and 268.

The radio content provider 210 and the commercial servers 229 can exchange information with each other. For example, the commercial servers 229 can send the radio content provider 210 reports about the commercial activity of the consumers. Or the radio content provider 210 can provide the digital media that is published by the commercial servers 229.

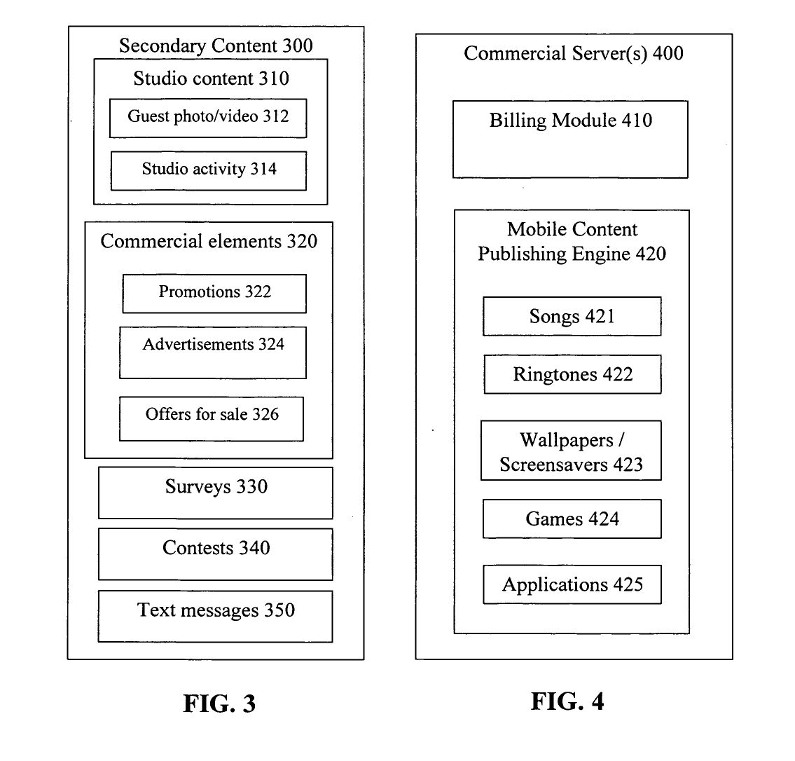

FIG. 3 illustrates an exemplary secondary content 300 for broadcasting along with primary media content in an interactive digital media streaming system, such as the system 100 (FIG. 1A) or the system 200 (FIG. 2A). In particular, the secondary content 300 can be used to implement the secondary content 112 (FIG. 1A) or the secondary content 212 (FIG. 2A). The exemplary secondary content 300 includes studio content 310, commercial elements 320, surveys 330, contests 340, and text messages 350.

The studio content 310 includes information related to activity in a studio that is maintained by a content provider to produce primary media content. In the particular example, the studio content 310 includes guest photo/video elements 312 and studio activity elements 314. The guest photo/video elements 312 can include still-image or video shots of one or more guests' activity in the studio, and the studio activity elements 314 can include still-image or video shots of general activity in the studio. For example, the studio activity elements can include shots of a show host, such as shots showing a DJ in a radio studio.

The commercial elements 320 relate to commercial activities, such as selling or buying, promoting, or advertising commercial products. Accordingly, the commercial elements 320 can include promotions 322, advertisements 324, and offers for sale 326 in the form of text or visual content, such as images, animations or videos.

The surveys 330 and the contests 340 typically require consumer participation that can provide valuable information for subsequent targeted advertisements or offers for sale. The surveys 330 and the contest 340 can include text or visual content elements, such as images, animation or video.

The text messages 350 can include chat-room activity, such as text messages from consumers or from a DJ. The text messages 350 can also include announcements from the content provider. For example, the announcements can announce programming information, such as guest lists, program schedules or future or parallel programming.

FIG. 4 illustrates commercial servers 400 that can be used in an interactive digital media streaming system, such as the system 100 (FIG. 1A) or the system 200 (FIG. 2A). In particular, the commercial servers 400 can be used to implement one or more of the consumer interaction servers 127 (FIG. 1A) or the commercial servers 229 (FIG. 2A).

The commercial servers 400 can receive, process, and respond to commerce related communications, such as orders to buy digital content or other goods, that are initiated by consumers in response to secondary content streamed along with primary media content in the interactive digital media streaming system.

The commercial servers 400 include a billing module 410 to process the received orders and, if required, request financial transaction or other information, for example, from other servers or the consumer device from which the order has been initiated.

The commercial servers 400 also include a mobile content publishing engine 420. Upon receiving an authorization from the billing module 410, the publishing engine 420 can transmit the ordered digital content to mobile consumer devices. In particular, the publishing engine 420 can provide songs 421, ring-tones 422, wallpapers or screensavers 423, digital games 424, and other digital applications 425.

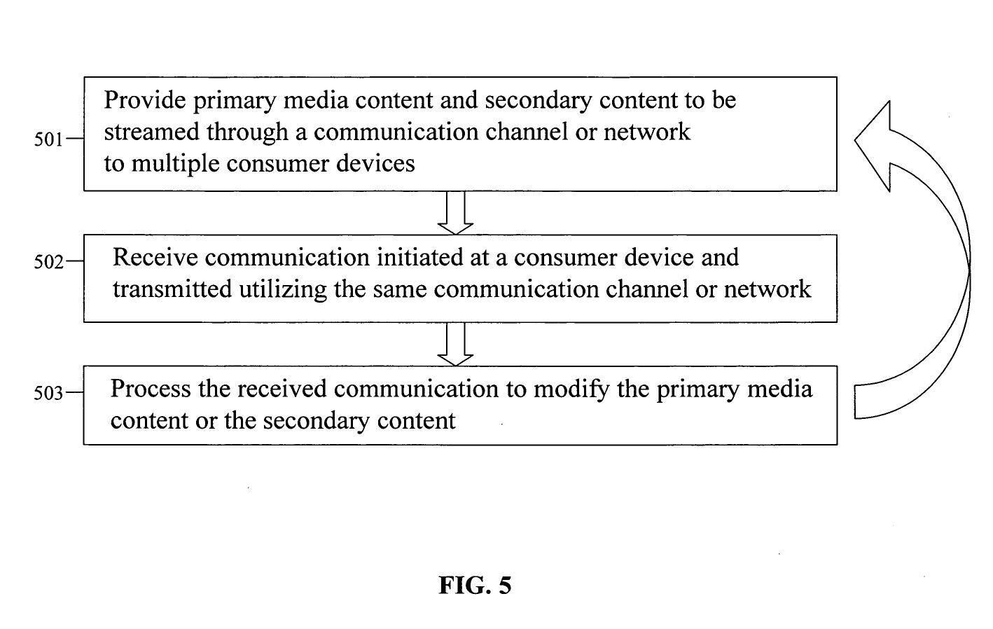

FIG. 5 illustrates a method 500 for establishing interaction between content providers and consumers. The method 500 can be performed by a system that includes a content provider, such as the content provider 110 (FIG. 1A) or the content provider 210 (FIG. 2A) in the interactive digital media streaming system 100 (FIG. 1A) or 200 (FIG. 2A), respectively.

The system provides primary media content and secondary content to be streamed through a communication channel or network to multiple consumer devices (step 501). The primary media content includes media programs of primary interest that are streamed to the consumer devices and presented to their respective users. The secondary content is streamed along with the primary media content, and includes content to be presented to the consumers in addition to the primary media content. For example, the primary media content can include radio or television programs, and the secondary content can include text, images or videos to be displayed while the consumer listens to a radio program or watches a television program. The primary media content and the secondary content are transmitted using a communication network, such as a wired or wireless network.

The system receives communication initiated at a consumer device and transmitted utilizing the same communication channel or network through which the primary media content and the secondary content has been received (step 502). The system processes the received communication to modify the primary media content (step 503), and returns to step 501. Thus, the system can initiate and establish real time interaction between the content provider and the consumers receiving the streamed content.

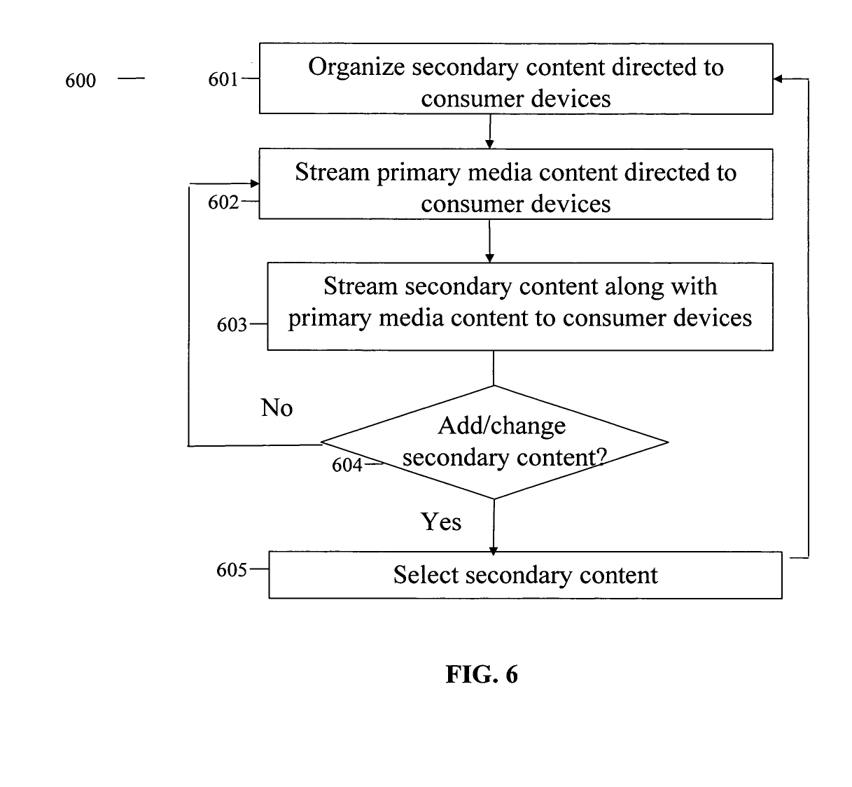

FIG. 6 illustrates a method 600 for selecting secondary content to be streamed with primary media content to multiple consumer devices. The method 600 can be performed by a system that includes a content provider, such as the content provider 110 (FIG. 1A) or the content provider 210 (FIG. 2A) in the interactive digital media streaming system 100 (FIG. 1A) or 200 (FIG. 2A), respectively.

The system organizes secondary content directed to consumer devices (step 601). For example, the system can retrieve secondary content elements from a data base and establish a timed sequence for streaming the retrieved secondary content elements according to a predetermined schedule or predetermined rules. In one implementation, the system uses an artificial intelligence device to organize the secondary content elements. The artificial intelligence device can retrieve and organize secondary content elements according to predetermined rules or other schedules such as artists' appearances or any other criteria. In operation, the artificial intelligence device can schedule and offer the secondary content elements as candidates for streaming.

The system streams primary media content directed to consumer devices (step 602). The system also streams the organized secondary content along with the primary media content (step 603). The system determines whether the secondary content should be changed or other secondary content should be added (decision 604). For example, the system can analyze the primary media content and request a change or an addition. In other cases, a system operator, such as a DJ, reviews the secondary content elements scheduled or offered by the artificial intelligence device, and provides user input to select, alter, delete or add elements to the secondary content.

If no change is required (“No” branch of decision 604), the system returns to streaming primary media content (step 602). If the organized secondary content elements should be changed or new elements should be added (“Yes” branch of decision 604), the system selects secondary content elements to be changed or added (step 605), and reorganizes the secondary content according to the selection (step 601). For example, the system can select and reorganize the secondary content elements based on user input.

In some embodiments the stream of secondary content is controlled not only by the personnel in the primary content provider 10 and 210, but has further administration points, where additional control can be exerted. For example, the interactive program provider 120 or the interactive radio provider 220, can insert ads, prepare assets for sale, create the stream, ingest playlist information and correlate that information to the stream. In such embodiments, when a particular song is playing, the associated assets, visuals, surveys, contest or purchase opportunities are presented at the right time. This control can be exerted within the radio station where the program originates. In some cases the entire radio program may have been constructed in a non-interactive manner, and all the interactive functionalities are added by the service provider, such as associated offers for sale. Many of these functionalities can also be automated, reducing the need for human operation and supervision.

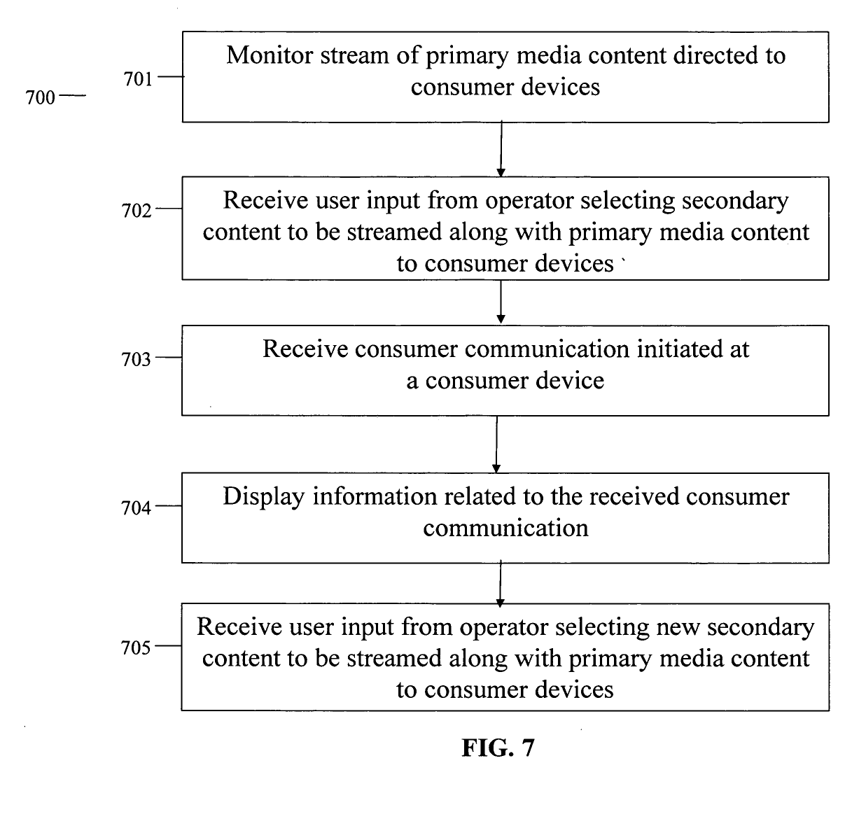

FIG. 7 illustrates a method 700 for establishing interaction between content providers and consumers. The method 700 can be performed by a system that includes a content provider, such as the content provider 110 (FIG. 1A) or the content provider 210 (FIG. 2A) in the interactive digital media streaming system 100 (FIG. 1A) or 200 (FIG. 2A), respectively.

The system monitors a stream of primary media content directed to consumer devices (step 701), and receives user input from an operator of the content provider (step 702). The received user input selects secondary content to be streamed along with the primary media content to consumer devices.

The system also receives consumer communication (step 703), where the consumer communication has been initiated at a consumer device that has received the streamed primary media content and the secondary content streamed along with the primary media content.

The system displays information related to the received consumer communication (step 704). If a system operator decides, based on the displayed information, that the secondary content should be changed, the operator can enter user input into the system. Thus, the system receives user input from the operator selecting new secondary content to be streamed along with the primary media content to the consumer devices (step 705). Thus, the system can initiate and establish real time interaction between the content provider and the consumers receiving the content.

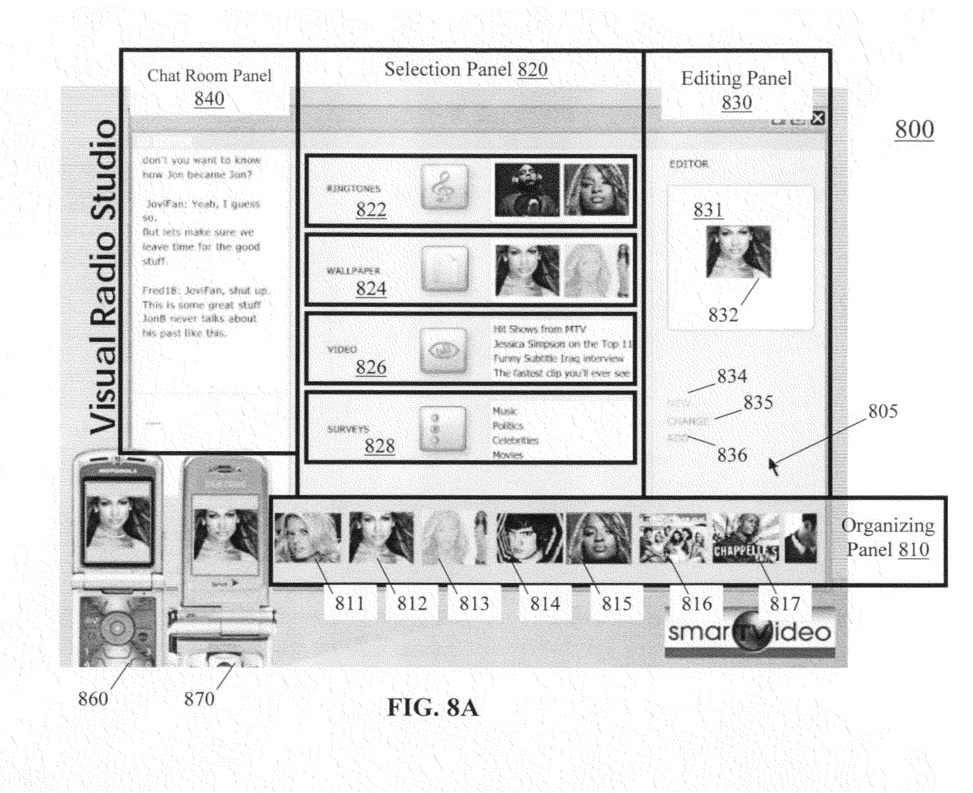

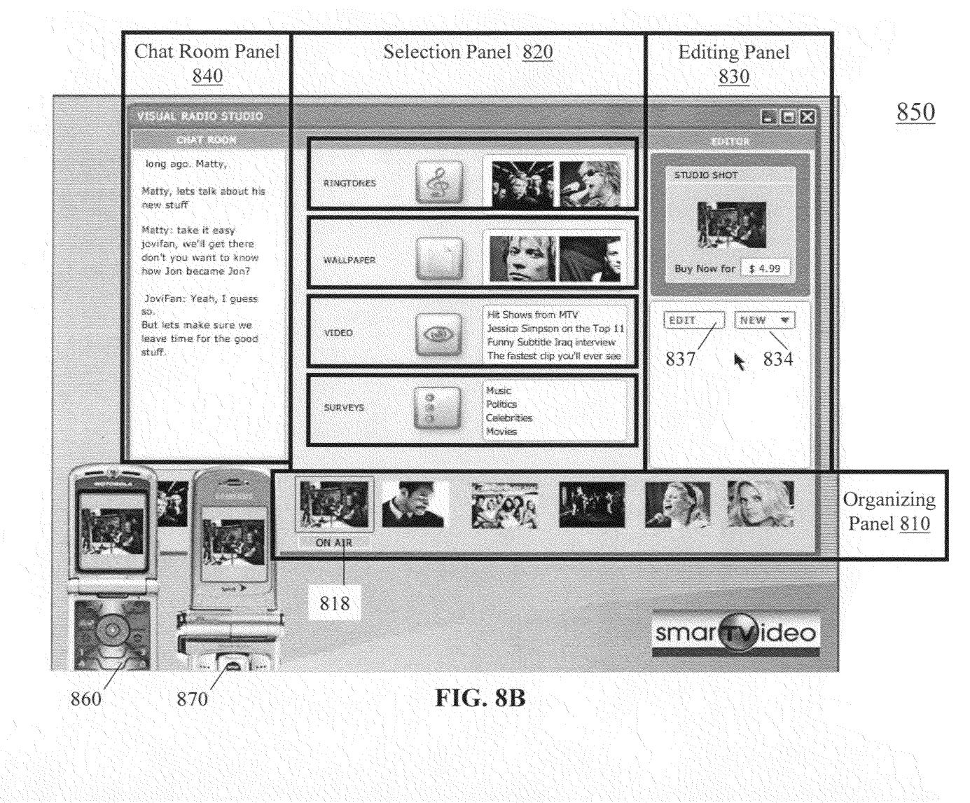

FIGS. 8A and 8B illustrate exemplary screen shots 800 and 850, respectively. The screen shots 800 and 850 can be generated by a user interface in a stream editor for an interactive digital media streaming system, where the user interface is configured to select and edit secondary content to be streamed along with primary media content to multiple consumers. In the example illustrated by the screen shots 800 and 850, the primary media content includes digital radio programs streamed to handheld wireless devices 860 and 870, and the secondary content includes textual and visual elements that can be displayed by the handheld wireless devices 860 and 870. In one implementation, the screen shots 800 and 850 are generated by the user interface 118 (FIG. 1A) or the user interface 218 (FIG. 2A) in the interactive digital media streaming system 100 (FIG. 1A) or 200 (FIG. 2A), respectively.

In FIG. 8A, the screen shot 800 includes a secondary content organizing panel 810, a secondary content selection panel 820, a secondary content editing panel 830, and a chat-room panel 840. The organizing panel 810 can be used to schedule secondary content elements to be streamed along with the audio content of the radio program. The selection panel 820 can be used to select secondary content elements that can be edited using the editing panel 830 or added to the scheduled content elements in the organizing panel 810. The chat-room panel 840 can be used to review text messages received from consumers and to select or add text messages to be streamed along with the audio content of the radio program.

The secondary content organizing panel 810 illustrates a sequence of secondary content elements 811-817 that are ordered according to a current schedule for streaming along with the audio content of the radio program. Each of the secondary content elements 811-817 is represented by a respective image so that a human user can easily identify the corresponding content element. In one implementation, the same images are streamed to the consumer devices as well. The selection, order, and timing of the secondary content elements 811-817 can be automatically determined by a preset schedule or according to predetermined rules. In one implementation, the secondary content elements 811-817 are first selected, ordered, and scheduled by an artificial intelligence device.

The secondary content organizing panel 810 allows an operator, such as a DJ, to alter the selection, order and timing of the secondary content elements 811-817. For example, the operator can use a cursor 805 to select and “drag and drop” one of the secondary content elements 811-817 to reschedule or remove the selected element. The operator can also add new secondary content elements into the organizing panel 810. The new content elements can be selected using the selection panel 820 or the editing panel 830.

The secondary content selection panel 820 includes a ring-tone selection unit 822, a wall paper selection unit 824, a video selection unit 826, and a survey selection unit 828. Using the selection units 822, 824, 826 and 828, the operator can select a secondary content element from a set of available ring-tones, wallpapers, videos, or surveys, respectively. Optionally, the selected content element can be edited using the editing panel, or directly added into the schedule specified by the organizing panel 810.

The secondary content editing panel 830 includes an editing window 831 and editing menu items NEW, CHANGE, and ADD 834-836, respectively. The editing window 831 includes a secondary content element 832 that is currently edited. After completing the edits, the operator can “drag and drop” the edited content element 832 to add it to the available content elements illustrated by the selection panel 820, or into the schedule specified by the organizing panel 810.

The operator can use the editing menu items 834-836 to alter the content element 832 or to select a new content element for editing. In particular, the NEW menu item 834 can be used to select a new secondary content element to be edited. For example, the NEW menu item 834 can be used to access a function that allows the operator to capture a live studio shot. The CHANGE menu item 835 can be used to change the selected content element 832. For example, the operator can change an image representation of the content element 832. The ADD menu item 836 can be used to add text or other elements to the edited content element 832.

The chat-room panel 840 illustrates text messages received from the consumers listening to the radio program. Thus, the operator can continuously monitor consumer reaction to the current streamed content. The chat-room panel 840 also allows the operator to add his or her own messages. In one implementation, the chat-room activity is streamed along with the radio program in addition to the secondary content scheduled by the organizing panel 810. Alternatively, the operator can add the chat-room activity into the schedule secondary contents specified by the organizing panel 810.

FIG. 8B illustrates the screen shot 850, which also includes the secondary content organizing panel 810, the secondary content selection panel 820, the secondary content editing panel 830, and the chat-room panel 840.

In the screen shot 850, the organizing panel 810 includes an ON AIR symbol 818 to indicate that a studio shot is currently streamed along with the radio program.

Furthermore, the editing panel 830 includes the studio shot as the secondary content element to be edited, and the studio shot is accompanied by an offer 833 for sale. The editing panel 830 also includes a new layout for menu items that are related to editing the studio shot. In particular, the NEW menu item 834 has a different presentation, and an EDIT menu item 837 is provided to access corresponding editing functions.

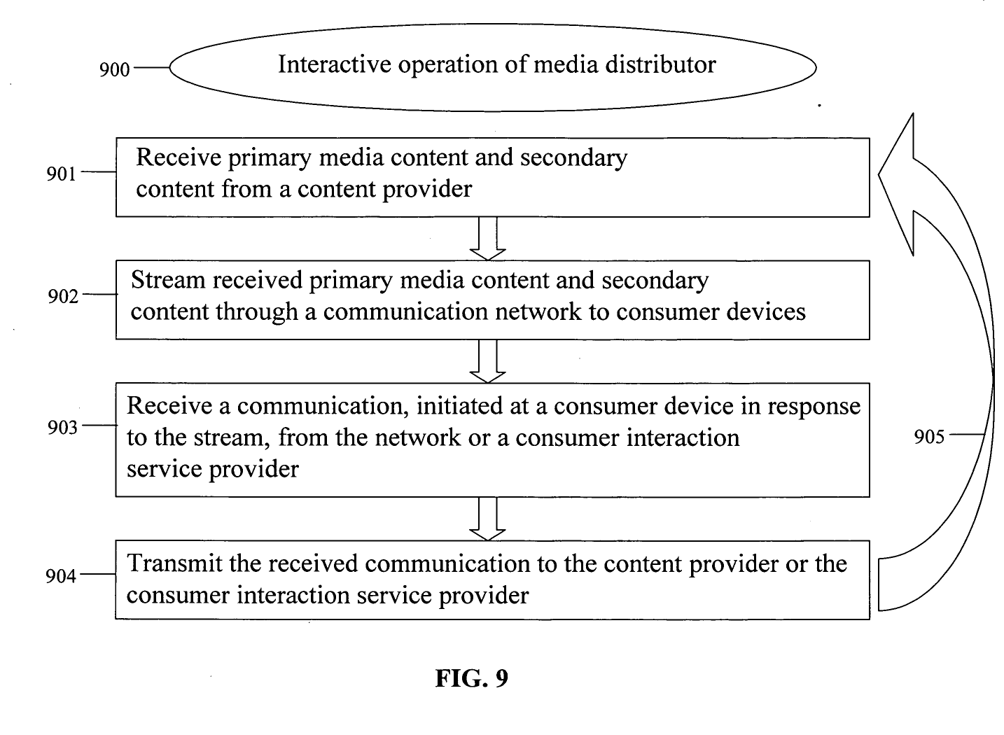

FIG. 9 illustrates an implementation of an interactive operation 900 of a media distributor.

In step 901 the media distributor receives primary media content and secondary content from a content provider.

In step 902 the media distributor forms a content stream from the primary media content and the secondary content in a stream server and streams the content stream through a communication network to consumer devices.

In step 903 the media distributor receives a communication which was initiated at a consumer device in response to the content stream. In some implementations the communication is received from a network, in others, from a consumer interaction service provider.

In step 904 the media distributor transmits the received communication to the content provider, or to the consumer interaction service provider. The media distributor and the consumer interaction service provider can share or exchange information. Thus, the media distributor can receive consumer information from the consumer interaction service provider, and the consumer interaction service provider can receive information about the content stream.

Steps 901-904 can be performed repeatedly in the course of the interactive operation, as represented by step 905.

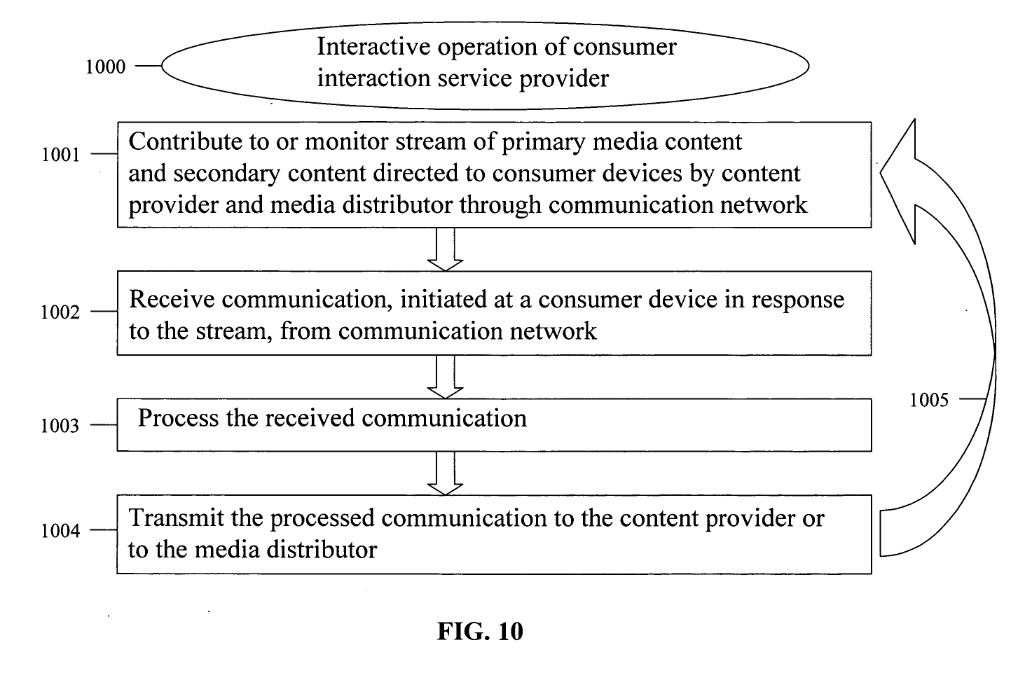

FIG. 10 illustrates an implementation of an interactive operation 1000 of a consumer interaction service provider.

In step 1001 the consumer interaction service provider contributes to or monitors a content stream of primary media content and secondary content directed to consumer devices by a content provider and a media distributor through a communication network.

In step 1002 the consumer interaction service provider receives a communication initiated at consumer devices in response to the content stream, from the communication network.

In step 1003 the consumer interaction service provider processes the received communication, partially or fully.

The consumer interaction provider can record, process, or forward the consumer communications. For example, the consumer interaction service provider can determine and record one or more features of the received consumer communications. The determined and recorded features can include survey or contest results, individual or overall responses to advertisements or promotions, or other statistical features of the consumer communications. These features include how long a consumer takes to respond to a program content, what styles of the content the consumer responded, how many consumers are listening at any given time, how long do they listen to a program, etc.

The consumer interaction service provider can also create, manage and update a consumer data base based upon the received consumer communications. The database can be organized according to any targeted consumer characteristics. It can be organized on an individual level, recording the listening and activity patterns of the consumers individually, allowing program selectors to personalize subsequent advertisements. Or it can be based on geographic area (in relation to area codes). Or it can be organized in cooperation with databases of the network, where additional consumer information is available.

In step 1004 the consumer interaction service provider transmits the processed communication to the content provider, to the media distributor, or to other service providers, such as order fulfillment services.

Steps 1001-1004 can be performed repeatedly in the course of the interactive operation, as represented by step 1005.

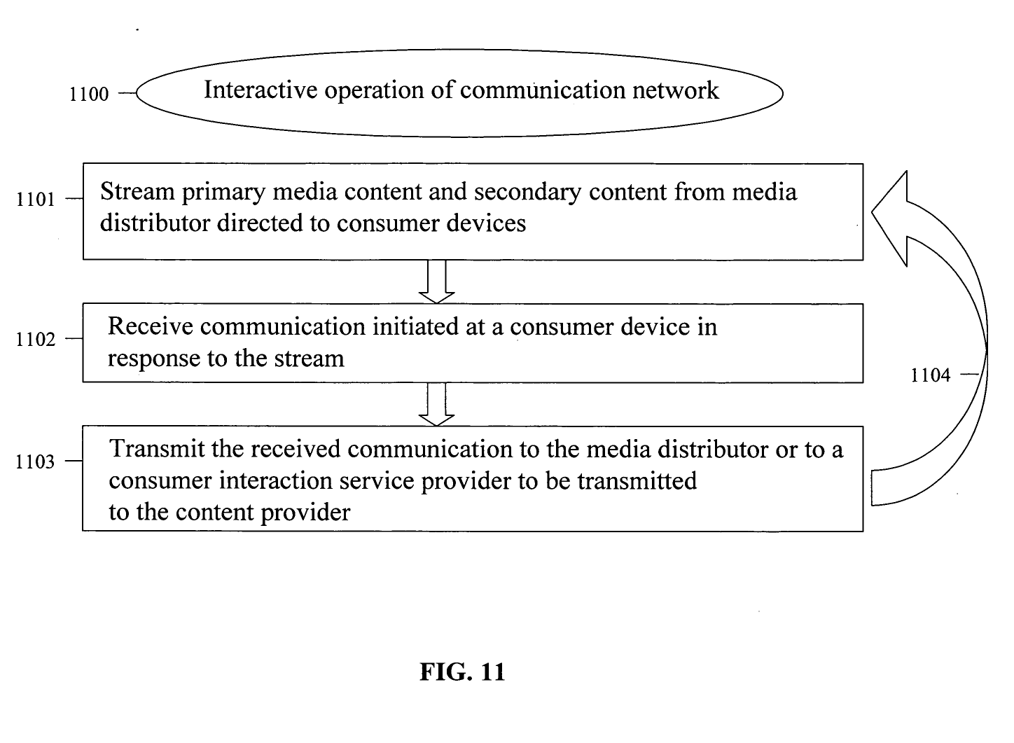

FIG. 11 illustrates an implementation of an interactive operation 1100 of a communication network.

In step 1101 the network streams a content stream created from a primary media content and a secondary content from a media distributor directed to consumer devices.

For example, the communication network can include public or private, wired or wireless networks that cover many consumer devices or a large geographical area. Thus, the communication network can include, at least in part, the Internet, wide area networks (WANs) or local area networks (LANs), cable networks, wired or wireless telephone networks. The network can include any combinations of the above systems, such as a voice over internet protocols (VoIP), which combine telephone networks and the Internet. The communication network can transmit the content stream using broadcast, multicast or unicast directed to each of the consumer devices.

In some implementations, the primary media content can be a radio show, which is streamed on the voice channel or band, whereas the secondary content is a visual image of the guest of the radio show, or a text message related to the guest, or the transcript of the show, or a promotion, or a contest. Any of these secondary contents can be streamed over a data channel, or sideband, of the network. Reserving a side band or data channel for the secondary content allows an easier organization and management of the interactive operations of the system.

In step 1102 the network receives communication initiated at a consumer device in response to the content stream.

In step 1103 the network transmits the received communication to the media distributor or to a consumer interaction service provider, to be transmitted to the content provider. This step exemplifies that in this method the consumer can interact with the content provider.

Steps 1101-1103 can be performed repeatedly in the course of the interactive operation, as represented by step 1104.

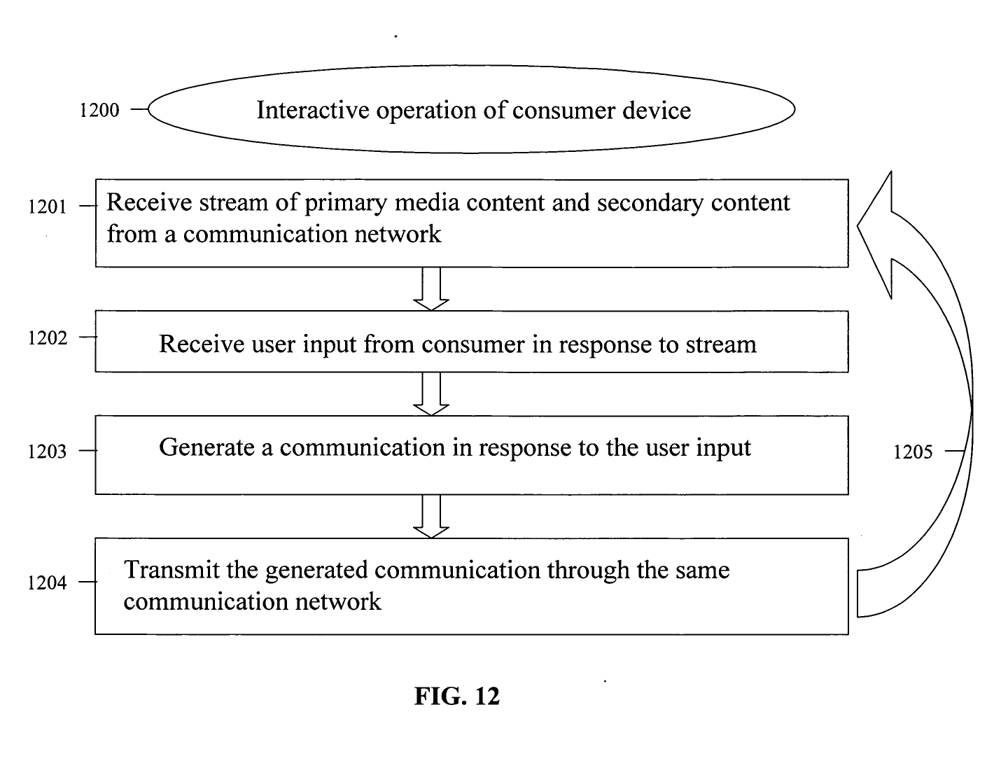

FIG. 12 illustrates an implementation of an interactive operation 1200 of a consumer device. The consumer device can be any one of a wide variety of devices. It can be a cell phone, a personal digital assistant (PDA), any portable communication device, such as a laptop, a pocket PC, a portable radio, a television device, and any variations, capable of receiving digital information and transmitting information in return. In step 1201 the consumer device receives a content stream, assembled from a primary media content and a secondary content, from a communication network.

In one example, the consumer device receives the content stream at a stream receiver. The consumer device may contain a consumer interaction unit, which displays a representation of the secondary content of the content stream.

The streamed content can be a wide variety of information. The primary media content can be a talk show or a music program broadcast by a radio studio. It can have a live host, such as a talk show host or a disc jockey. Or it can be a program with a broadcast manager, who organizes, edits or manages the broadcast but does not provide audible input.

The secondary content can be any one of a very wide variety of information. It can be a promotion, a representation of the text entries of a chat-room, information regarding the guest of the show, the radio station, or an upcoming program. It can be an image of the guest, an image related to the guest, a low resolution, low refresh rate video (“lite-video”) related to the guest (such a music video), a lite-video of a studio activity, a contest, a survey, a community announcement or any analogs.

In step 1202 the consumer device receives user input from a consumer in response to the content stream. The consumer input can again be a very wide variety of inputs, enabled by the applications available on the consumer device. For example, a customer interaction unit of the customer device can provide an interactive interface involving a display of the customer device. The interface can involve selectable icons, which can be selected by keys of the device, identified on the screen. The interface can also include a chat-room application. For this application the consumer enters the input by the letter keys of a keyboard. If the consumer device is a laptop, then all known computer input channels are available for the consumer.

The consumer interface is intuitive and flowing. It includes scrolling interactive graphics and text, links to mobile commerce and embedded video and audio clips. Some implementations allow for blogging from the consumer device, managing subscriptions and coordinated SMS messaging and alerts. The applications make it easy to choose from hundreds of radio stations, images and videos. The applications also have a flexible design: they are capable of supporting various business models, including subscription sales, supported by “on-deck” carrier distribution, or direct sales to the consumers, advertising, and sponsorship utilizing both on and off deck billing solutions.

Some applications are developed for Java 2 Micro Edition (J2ME) enabled devices. Some applications are developed on the Binary Runtime Environment for Wireless (BREW) platform. BREW is ideally suited to creating powerful applications on memory/footprint-constrained devices. One of the ways BREW is able to do this is by working with truly compiled code that has been written in languages such as C and C++. The applications feature a fully graphical interface, and include one or more of the following capabilities:

Streaming audio;

Light video presentation, which involves 15 second clips in motion JPEG format;

Interactive chat clients;

Scrolling interactive graphics and text;

Links to mobile commerce;

Personalization features;

Visual radio;

Interactive radio platforms for contests, promotions and polling;

Interactive customer relationship management (CRM) systems;

Promotional Messaging and coupon systems;

On phone subscription management for premium channel pay-per-view (PPV) that can support web community boards;

On deck and Web mobile content sales with server side distribution systems;

Porting capabilities to other desktop and mobile devices.

The server infrastructure, implementations of which include the consumer interaction servers 127 within the consumer interaction service provider 125, and the consumer interaction manager 117 within the stream editor 115, all in FIG. 1A and 2A, includes the following functionalities:

Ability to deliver the above described contents to the consumer devices;

Manage the consumer personalization of client applications, in some cases over the phone, in others over the Internet;

Gather, process, organize and report the statistics of relevant elements of channel usage, and profiling of consumer behavior patterns.

In step 1203 the consumer device generates a communication in response to the user input. In an example, the communication is generated in a consumer interaction unit. The communication can be a direct communication, as entered by the customer. Or the communication can be an indirect communication, e.g. a report regarding the consumer. Examples include data regarding the listening habits of the consumer, the response time of the consumer, an indication that the consumer tuned in or out from the radio program.

In step 1204 the consumer device transmits the generated communication through the same communication network, towards a content provider, or a media distributor, or a consumer interaction server, which can be part of an interactive program provider.

Steps 1201-1204 can be performed repeatedly in the course of the interactive operation, as represented by step 1205.

The implementations of these interactive methods do not interfere with the primary function of the consumer device. For example, if the consumer device is a cell phone, then the phone continues to operate as a cell phone (receive phone calls etc.) while also performing the above implementations.

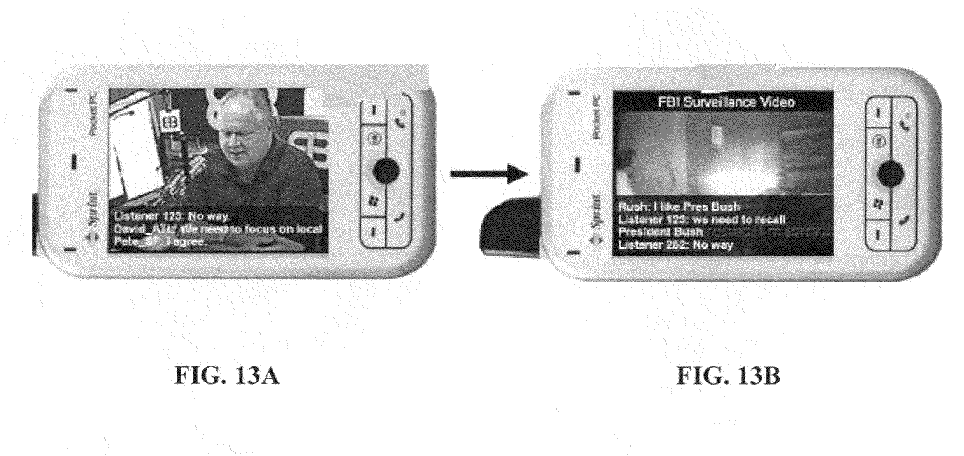

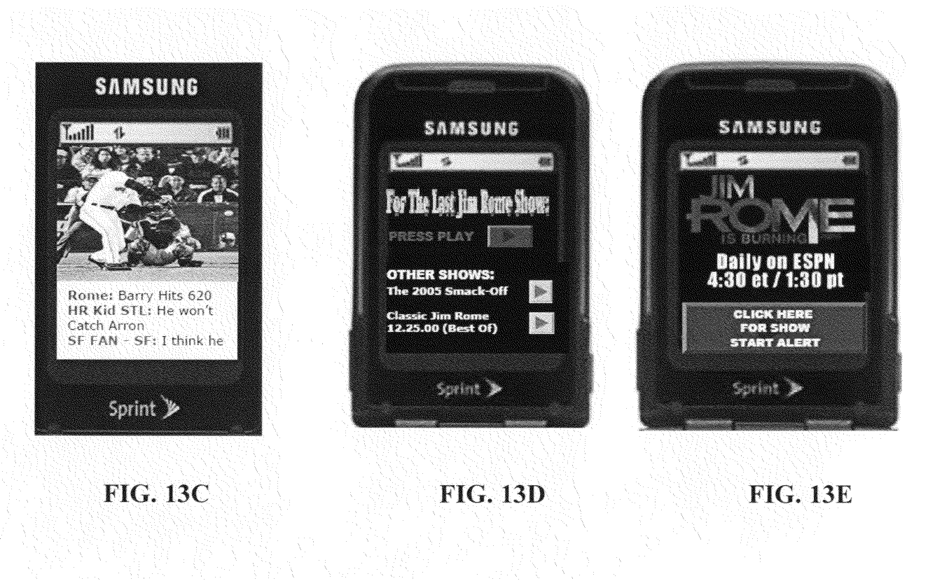

FIGS. 13A-D illustrate various features and functionalities of consumer devices. In particular, a feature of several implementations of the interactive method of FIGS. 5-13 is that the primary media content can be reflective of the consumer communication, since the consumer communication is transmitted, either directly, or after some processing, all the way back to the content provider.

FIG. 13A illustrates an implementation, where the primary content is a talk show hosted by a radio personality. Here the primary content is the digital audio stream or the radio program. The secondary content maybe an instant photo of the host, taken in the studio as shown in FIG. 13A. Or it can be a previously shot photo of the host. Or a photo of the studio. Or a lite-video of the studio activity.

FIG. 13B illustrates a lite-video, selected by the host or a producer of the show. In addition, the secondary content may include a display of entries of a chat-room, as shown in FIGS. 13A-C. The secondary content can also include a promotional message, such as the time of the concert of a guest, or the title of her book; or information on a contest, such as alerting the consumers for a competition to get a ticket for the concert of the guest; or an instant messaging (IM) application, inviting consumers to communicate with the guest.

In any of the above implementations, the radio personalities (the guest and the host) have the opportunity to interact with the customers. E.g. in the implementation of FIG. 13A the secondary content is a photo of the host (Rush Limbaugh), and the latest entries into the program-related chat-room. FIG. 13B illustrates that the radio personality (Rush Limbaugh) himself can send an entry to the chat-room (“Rush”).

FIG. 13C illustrates a related implementation, where the host of a sports show (Jim Rome) displays a photo of a baseball event and related sports data, as one of the secondary contents, and in addition chat-room entries are visible in the lower portion of the display, as another secondary content. In this chat-room the consumers can interact with the host, as the host can respond to the consumer's comments (see chat-room entry “Rome”). The host's response gives rise to an edited content stream.

The host and the consumers can also interact through a short message service (SMS) and pSMS systems. Such interactive systems allow for voting implementations, surveys, and contests. In voting systems the radio personality poses questions and the consumers respond through chat-rooms, instant messaging or SMS. A consumer interaction services provider can process, summarize and tabulate the results of the vote and relay the processes summary to the radio personality. In surveys, similarly, the consumers can respond to the host's questions, which are posed either in the primary media content, e.g. live on the radio show, or in the secondary content, e.g. in the text box.

In some embodiments, instant messages (IMs) can also be transformed into SMS and pSMS billing events

FIG. 13D illustrates another implementation. Here the secondary content includes consumer choices, such as prompters to access prerecorded programs (“classics”) or shows. The secondary content also includes consumer interaction display elements, in the present case selectable icons. These selectable icons allow the consumer to indicate to the content provider their intent to access a particular show, pre-recorded or live. In some implementation a selectable icon is “Play”. This implementation is a type of “on-demand” application. By “pressing” (activating) the icon, the consumer can access the indicated program. In response, the content provider can broadcast or stream the requested program. During this broadcast or stream, even if the program was pre-recorded and thus the broadcast does not involve a live host, a program manager or producer can generate secondary content, e.g. in the form of photos of the artist or talk show host, or any number of advertisements. If the consumer joins a pre-scheduled re-broadcast, the consumer can join a chat-room and exchange messages with other consumers, listening to the same program.

FIG. 13E is an implementation where the interaction between the consumer and the content provider takes the form or “show alerts”. The secondary content alerts the listener that the show time of a desired show is coming up. In some implementation the reminder or alert can take the form of a phone call, or the on-board processor of the consumer device records the show time during an earlier interaction with the content provider and alerts the consumer when the actual show time approaches. The alerts can take many forms: traffic alerts, alert to buy tickets for desired shows, sport-related alerts, alerts related to weather forecast or changes.

A feature of some of the above implementations is that radio programs, which were previously available only in geographically restricted areas become available to customers in a much larger region with service for cell phones.

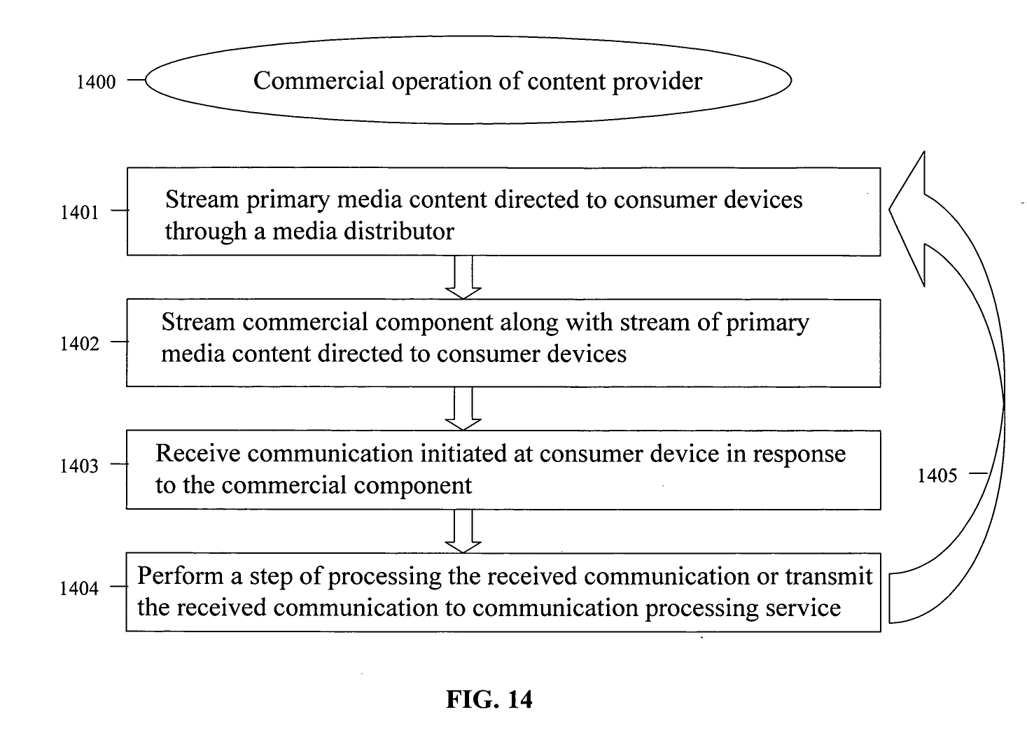

FIGS. 14-20 illustrate an implementation of a commercial operation of the main elements of an interactive digital media streaming system. In this implementation the content provider can be the content provider 210 of FIG. 2A or analogs, the primary media content can be the primary media content 211 or analogs, the secondary content can be the secondary content 212 or analogs, the media distributor can be media distributor 221 or analogs, the consumer interaction service provider can be the consumer interaction service provider 225 or analogs, the communication network can be the communication network 230 or analogs, the consumer devices can be the consumer devices 240 and 245 or analogs, the content stream can be the content stream 250 or analogs, the communications can be the communications 260 or 265 or analogs. In some implementations media distributor 221 and consumer interaction service provider 225 are part of interactive program provider 220. In some implementations consumer interaction service provider 225 includes message servers and commercial servers.

In some implementations the above elements can be the corresponding elements in FIG. 1 or equivalents. Furthermore, in some implementations the secondary content can be the secondary content in FIG. 3. In some implementations the commercial server of FIG. 4 can be part of the consumer interaction service provider. In some implementations incorporate any combination of the above elements.

FIG. 14 illustrates a commercial operation 1400 of a content provider.

In step 1401 the content provider streams a primary media content directed to consumer devices through a media distributor.

In step 1402 the content provider streams a commercial component along with the stream of the primary media content directed to consumer devices.

In step 1403 the content provider receives a communication initiated at a consumer device in response to the commercial component.

In step 1404 the content provider performs a step of the processing of the received communication, or transmits the received communication to a communication processing service.

Steps 1401-1404 can be performed repeatedly in the course of the interactive operation, as represented by step 1405.

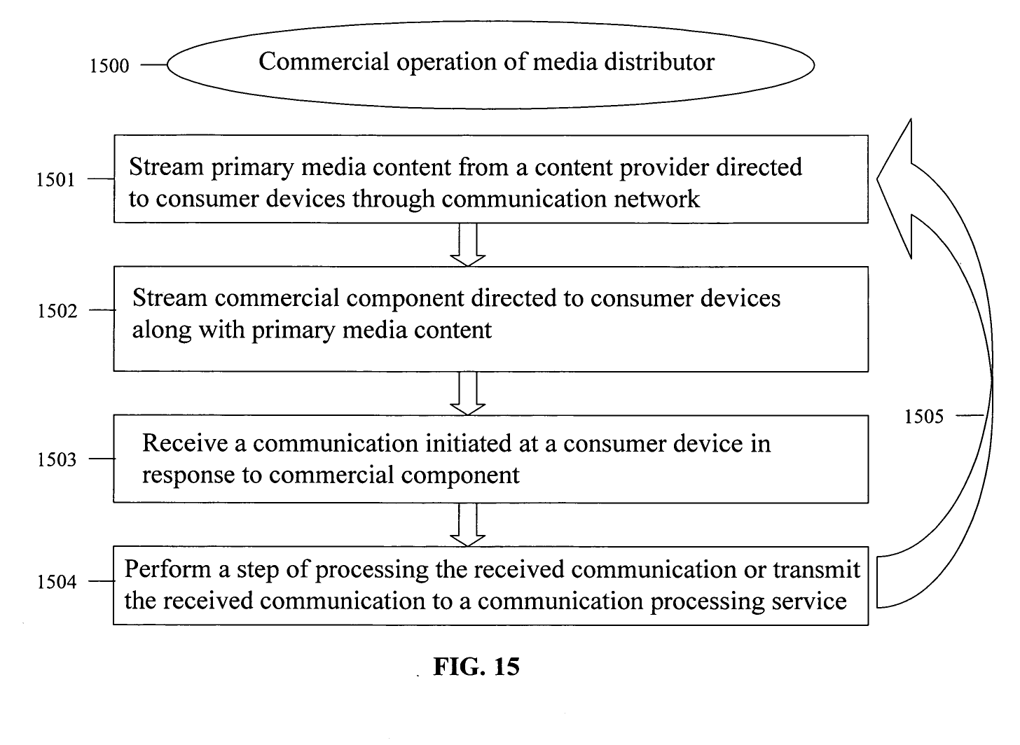

FIG. 15 illustrates a commercial operation 1500 of a media distributor.

In step 1501 the media distributor streams a primary media content, received from a content provider and directed to consumer devices, through a communication network.

In step 1502 the media distributor streams a commercial component, directed to consumer devices, along with the primary media content.

In step 1503 the media distributor receives a communication initiated at a consumer device in response to the commercial component.

In step 1504 the media distributor performs a step of processing the received communication, or transmits the received communication to a communication processing service.

Steps 1501-1504 can be performed repeatedly in the course of the interactive operation, as represented by step 1505.

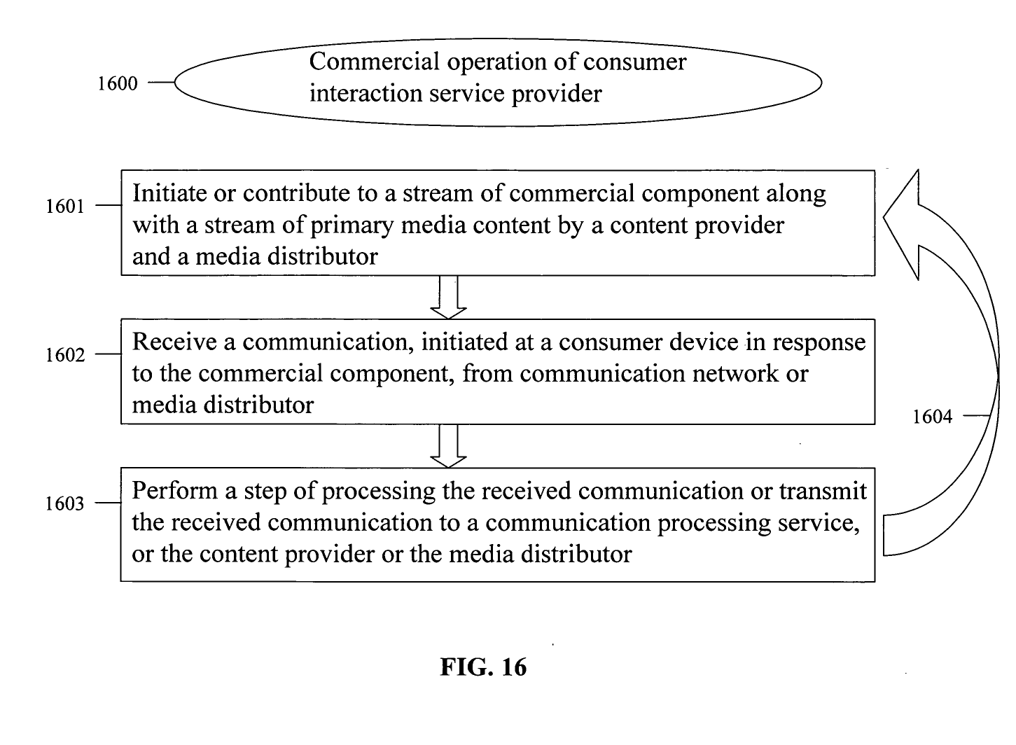

FIG. 16 illustrates a commercial operation 1600 of a consumer interaction service provider.

In step 1601 the consumer interaction service provider initiates or contributes to a stream of a commercial component along with a stream of a primary media content, streamed by a content provider and assembled by a media distributor.

In step 1602 the consumer interaction service provider receives a communication, initiated at a consumer device in response to the commercial component, from a communication network or the media distributor.

In step 1603 the consumer interaction service provider performs a step of processing the received communication, or transmits the received communication to a communication processing service, or the content provider or the media distributor.

The consumer interaction provider can record, process, or forward the consumer communications. For example, the consumer interaction service provider can determine and record one or more features of the received consumer communications. The determined and recorded features can include survey or contest results, individual or overall responses to advertisements or promotions, or other statistical features of the consumer communications. These features include how long did the consumer take to respond to an advertisement, how many times the consumer makes a transaction during a session, what features of the content the consumer responded to, among others.

Steps 1601-1603 can be performed repeatedly in the course of the interactive operation, as represented by step 1604.

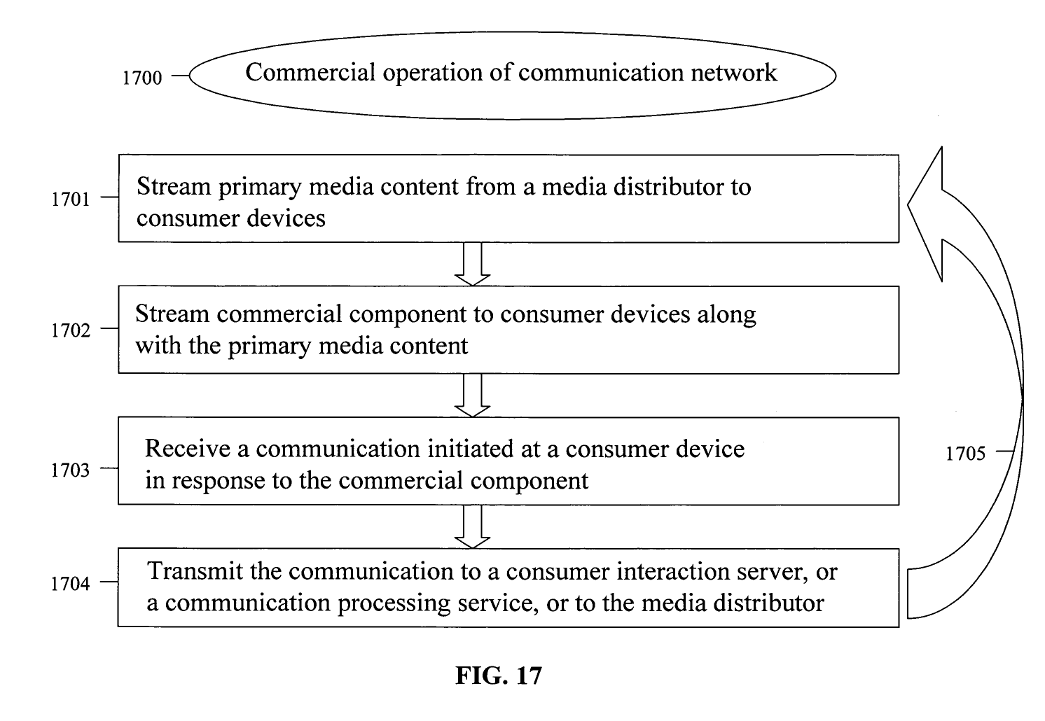

FIG. 17 illustrates a commercial operation 1700 of a communication network.

In step 1701 the communication network streams the primary media content from a media distributor to consumer devices.

In step 1702 the communication network streams a commercial component to consumer devices along with the primary media content.

In step 1703 the communication network receives a communication initiated at a consumer device in response to the commercial component.

In step 1704 the communication network transmits the communication to a consumer interaction server, or to a communication processing service, or to the media distributor.

Steps 1701-1705 can be performed repeatedly in the course of the interactive operation, as represented by step 1705.

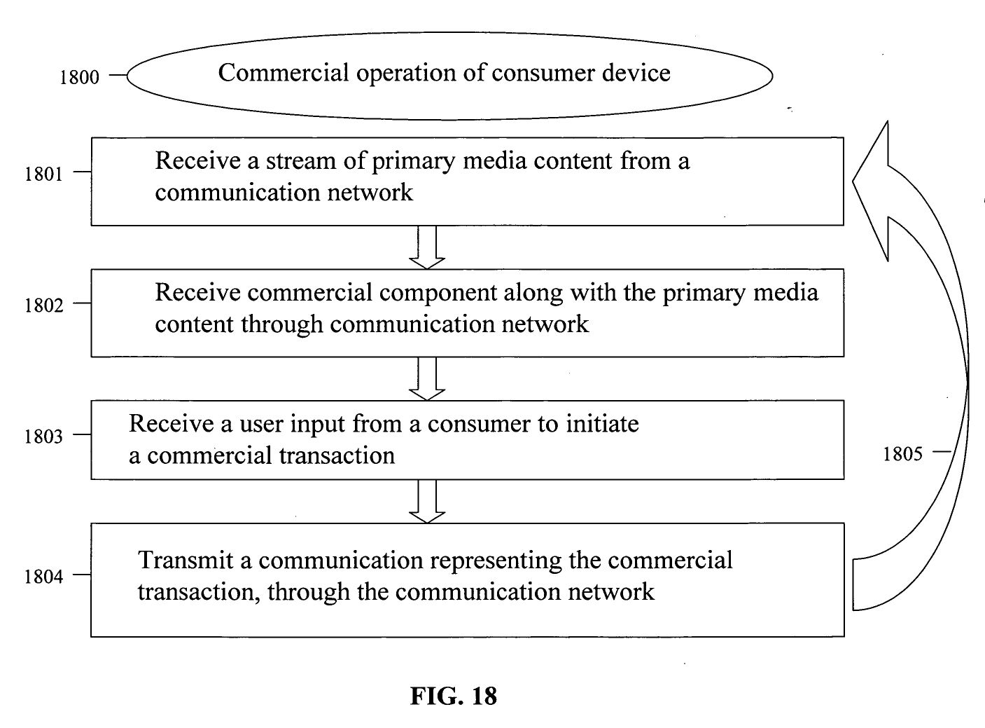

FIG. 18 illustrates a commercial operation 1800 of a consumer device.

In step 1801 the consumer device receives a stream of a primary media content from a communication network.

In step 1802 the consumer device receives a commercial component along with the primary media content through a communication network.

In step 1803 the consumer device receives a user input from a consumer to initiate a commercial transaction.

In step 1804 the consumer device transmits a communication, representing the commercial transaction, through the communication network.

Steps 1801-1804 can be performed repeatedly in the course of the interactive operation, as represented by step 1805.

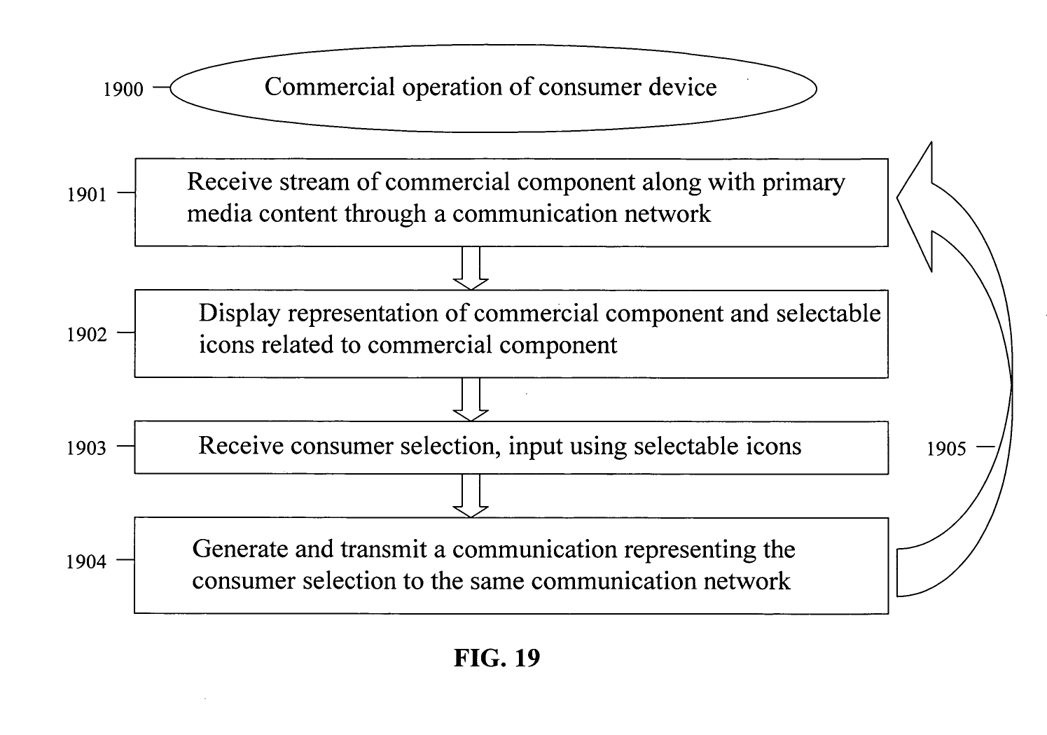

FIG. 19 illustrates a commercial operation 1900 of a consumer device.

In step 1901 the consumer device receives a stream of commercial component along with a primary media content through a communication network.

In step 1902 the consumer device displays a representation of the commercial component and selectable icons related to the commercial component.

In step 1903 the consumer device receives a consumer selection, input by a consumer using the selectable icons.

In step 1904 the consumer device generates and transmits a communication representing the consumer selection to the same communication network.

Steps 1901-1904 can be performed repeatedly in the course of the interactive operation, as represented by step 1905.

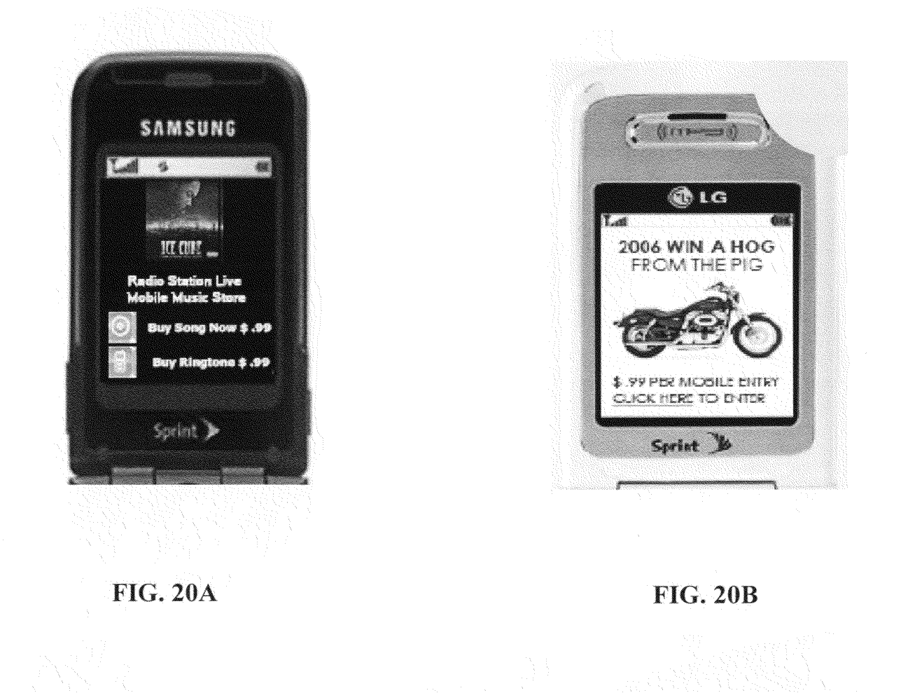

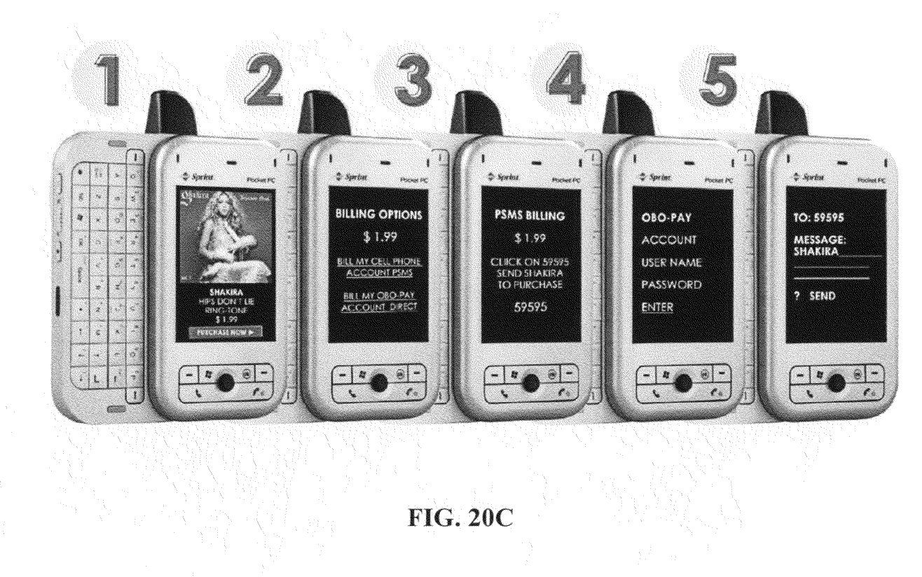

FIGS. 20A-C illustrate various features and functionalities of the commercial operation.

FIG. 20A illustrates an implementation where the commercial component of the content stream includes a photo related to a song, which is played as the primary media content. This could be the cover of the album or a promotional photo of the artist. The commercial component further includes offers for sale (“Buy this song”, “Buy ring-tone”) in the form of selectable icons. The consumer can select one of these icons. The consumer device then generates an order to buy message and transmits it through the network to the consumer interaction service provider. The consumer interaction service provider can either process the order to buy itself, or it can forward it to the media distributor or the content provider. The transaction involves delivering the ordered product: in the present implementation the downloading of the ordered song, or the ring-tone to the phone. In implementations this can be performed by the consumer interaction service provider, the media distributor, by the content provider, or a separate order fulfillment service. More specifically, at the content provider either the host of the music program or specialized personnel at the radio studio can download the program to a cell phone. In other cases, the order to buy can be forwarded to an online music store, which fulfills the order.

Besides songs and ring-tones, any other digital products can be subject of such commercial transaction. For example, consumers could access games, screensavers, electronic “wallpapers”, or any type of applications.

All of these products can be advertised as part of the secondary content. The advertisements can include interstitials, banners, ad serving, sponsored presentations, sponsored contesting, sponsored custom applications, audio commercials, even text messaging.

FIG. 20B illustrates an implementation involving contests. The host of the primary media content selects as a secondary content an invitation to a contest. Upon some form of payment, the consumer's number is recorded. The payment can be a simple fee for every call, or a credit card payment, or any other electronic form of payment. The contest closes by a system of selection among the consumers, who entered the contest.

FIG. 20C illustrates a commercial transaction on a pocket PC type consumer device, sometimes referred to as “Auto PSMS queuing”. In step 1 the commercial component includes an image related to a song, the photo of the artist. The commercial component also includes an offer to sell a ring-tone and a consumer-selectable icon (“purchase now”), allowing the consumer to initiate a transaction.

In step 2, after the consumer inputs an order to buy, the consumer device sends a communication to the consumer interaction service provider. In response, the consumer interaction service provider displays various billing options. These options include billing the cell phone of the consumer, involving a PSMS account, possibly billing through an OBO-pay account, which is an electronic payment service supporting on-line transactions. Other methods of billing can be also utilized, e.g. pay-pal type billings, or pre-paid accounts, or linkage to regular credit card-based systems, or direct access to a bank account of the consumer.

In step 3 the consumer selects the PSMS system to pay. In this system of payment the consumer previously established an account. Now the consumer can designate or authorize the payment with a short SMS description (“shakira”) and the corresponding (address) code. Step 4 illustrates the use of the OBO-pay option, which uses a prepaid account, accessed by typing in a username and password. In step 5 the consumer enters the (address) code in the “to” field, and the product identifier “shakira” into the message field, and then sends the message, effecting the purchase of the ring-tone.

As discussed above, the commercial transactions can be implemented in an integrated manner. Thus, the consumer can pay for a selected product or download without stopping the currently running application, and subsequently carrying out the payment authorization with a separate message using short codes, and then restarting the original application. Instead, the original application can remain active while the payment is effected in real time. The system can be implemented to use one or more billing systems, including a PSMS system or a mobile wallet, which can be tied to a credit card or third party billing system.

In some implementations, the consumer accesses the above services by subscribing for a monthly fee. To access the service the end user downloads an embodiment of this implementation onto the mobile device or handset.

The monthly fees can be collected in some embodiments by the provider of the interactive digital service provider. This can include credit card billings or any other financial transaction, involving bank cards, cash cards, bill-me-later arrangements or any equivalents. The consumer can sign up to the service for example through the Internet, or by directly contacting the phone service provider. In some embodiments the wireless carrier company adds the charges to the monthly bill of the end user.

The subscription can be on various levels. There can be a base subscription product, which provides access to a number of radio stations (of any genre and market). These radio stations can be chosen from a wider selection. The choice can be modified at any time during the subscription period. In other embodiments a wider selection of radio stations is available.

Some embodiments may include premium products for added cost. These could include radio stations broadcasting the programs of popular, nationally recognized radio personalities, such as talk show hosts and disc jockeys. Any combination of base products and premium products can be provided as well.

An aspect of some embodiments is that the end user can purchase the digital goods while listening to the radio program on the handset. This synchronous presentation of the content and the offers to sell constitute a “contextual commerce”, enhancing the potential for cross-sales.

The term “m-commerce” refers to mobile commerce, i.e. commercial transactions involving mobile electronic devices. Examples of “digital goods” include ring tones, screen savers, games, graphics, any applications, even CDs and T-shirts, concert tickets: any goods or services which can be purchased over mobile devices.

In m-commerce embodiments the sales can be individual, non-subscription based. Of course combinations of the two methods can also be implemented, where a monthly subscription enables individual purchases in the corresponding period. This m-commerce application bears resemblance to the iTunes business model.

Some embodiments include games which involve multiple players interacting. These games may require an action from an end user when away from non-mobile devices, thus providing a useful service. Other embodiments include mobile gaming, e.g. poker, slot machine equivalents, or any other casino type applications.

In any of the embodiments the end user's selection can be transmitted by regular text messaging, or its many variants, such as SMS and premium SMS (pSMS). pSMS is a carrier billing mechanism and a wireless opt-in vehicle for various interactive wireless services. pSMS can be used to charge a wireless user to participate in a vote, a poll or contest. pSMS can also be used to bill for a wireless download.

The above implementations can be integrated within the application to perform pSMS transactions directly from the application since the application session includes an identifier for the user that allows the system to query carrier SMS gateways for billing approval for charges.

In the following various business methods will be described in relation to the above interactive digital media services. As described, some embodiments support the interactivity of the service essentially on the same channel in both directions. In terms of FIG. 1, the content stream 150 from the content provider 110 and interactive program provider 120 to the consumer devices 140 and 145 can take place over the same network 130, as the interaction 160 and 165 from the consumer devices 140 and 145 towards the content provider 110 and interactive program provider 120. In the context of FIG. 2, the content stream 250 from the radio content provider 210 and interactive radio provider 220 to the wireless devices 240 and 245 can take place over the same wireless communication network 230 as the various aspects of the interaction, such as messages 262 and 267, and orders 263 and 268 from the wireless devices 240 and 245 back to the interactive radio provider 220 and in some embodiments to the radio content provider 210. In the following, the term “interactive media services” will include these same channel interactive media services.

Revenue generating services 2000 can include the following aspects of m-commerce.

Sale Service 2010: The operator of the primary media content provider, such as a disc jockey of a radio program, can offer for sale (i) static and (ii) dynamic assets in connection to the interactive media service. The static and dynamic assets are embodiments of the commercial elements 320 of the secondary content 300 in relation to FIG. 3. Examples of static assets include any tangible products, such as T-shirts, clothing items, CDs, concert tickets, and memorabilia. Static assets include any items, which are winnable or obtainable in relation to a program, such as jewelry or even cars and motor bicycles within a bidding, voting, or lottery program. Examples of dynamic assets include downloads of music, ring-tones, wallpapers, screensavers, games, any type of applications or software. These static and dynamics assets can be offered for sale in connection to the music being played, to a guest of the show, to a promotion campaign underway, a survey, a contest, or any other program associated with the interactive media services. The offer can be originated by the live operator of the media content provider, or any of his/her associates, on location or at any other associate facility. The offer can even be originated with a promotional software operation, without direct operator prompting. The sale service 2010 includes facilitating the transactions, which were prompted by the offers for sale. Examples include a user or listener initiating a purchase of an offered band-memorabilia during a talk show with the band.

Advertisement Service 2020: The operator of the primary media content provider, such as a radio talk show host, can also present any types of advertisements in relation to any program associated with the interactive media services. Examples include advertising a concert of a guest of the show, a book signing event, a new product of a guest inventor, and any variations. The advertisements can be displaying an image on the display of a wireless device, such as the picture of a CD, or running a banner ad on the top or bottom of the screen while showing a live camera shot on the display, or verbal mentioning of a static or dynamics asset by a disc jockey. In all variations the offer can be made by any associate, or business relation of the operator. In all variations the offer can also be made by a provider who works without the express authorization of the operator of the primary media content provider. Examples include an independent contractor, who places the offers for sale without the express orders of the talk show host, possibly even from a remote location. The advertisement service 2020 includes facilitating the transactions, which were prompted by the offers for sale. For example, a user or listener can initiate a purchase of an offered band-memorabilia during a talk show with the band.

Responsive Service 2030: The operator of the primary media content provider, or any affiliate. Business associate, or independent contractor, can also initiate an interactive, or responsive primary program, including a survey, contest, polling, voting, betting, lottery, auction, bidding, or any analogues. In the context of this interactive media service the operator (or equivalents) can offer for sale, or for win, any of the above, such as static and dynamic assets. Examples include bidding for the guitar of the guest of a disc jockey, voting for the most popular song of the guest band and win their greatest hits CD plus a ticket for their upcoming concert, and many more. The responsive service 2030 includes facilitating the transactions, which were prompted by the interactive media program. A user or listener paying up after an interactive bidding program is such an example.

Community Service 2040: The interactive media services include moderated p2p communities and offers for sale in association with operating this moderated community. Examples include a chat room, which operates as a fan club of a pop star, moderated by a radio personality, where wallpapers or ring-tones originating with the star can be purchased. The moderation service maybe preferred by users, e.g. parents may authorize their young children to visit moderated chat-rooms and services, while prohibiting the access to un-moderated ones for reasons of safety. Also, in these chat-rooms the star may log in on occasion, promising direct interactivity for the users. The community service 2040 includes facilitating the transactions, which were prompted by the mediated chat-room, or other p2p community. An example is a user or listener carrying out a purchase of a book, recommended by the moderator during an interactive session.

Targeting service 2050: The provider of the network, such as a cellular phone company, can in fact track the purchasing profiles of users of the interactive media service. For example, tracked purchasing patterns can include: price range, product categories, even times of the day preferred for purchasing by the individual users. Any other known profile can be measured as well, such as geographic distribution of the users, or potentially their account information, such as identity.

Tie-in service 2060: The targeting service may also allow enhanced tie-ins. E.g. if someone bought a particular item, then various estimators may indicate what other purchases the user is more likely to be interested in. Therefore, the operator of the interactive media program may make multiple promotional materials ready for offer, and for users who purchased an item, a second item which has a higher likelihood to be purchased, will be offered from the multiple promotional materials. As an example, if several bands participate in a concert tour, then the material of all bands can be made available in parallel. When a user purchases the T-shirt of one of the bands, then the CD of the same band may be offered automatically by this tie-in service

The targeting service 2050 and tie-in service 2060 promise a greatly enhanced return on advertising investments.

The above examples of revenue services offer direct revenue-opportunities 2002 in association with this interactive media service. There are, of course numerous opportunities for indirect revenue 2004 as well. These include not collecting the revenue through the interactive service, but e.g. directing the revenue stream through other service providers. Examples include the DJ of an interactive program taking SMS messages in relation to the guest of the show and directing them to a web page where a purchase can be made.

Various media partners 2100 may participate in the providing of the above revenue generating services 2000. These media partners 2100 may include:

Source Partner 2110: The radio program content source, the program provider, the program facilitator, any types of a radio or TV studio, including independent content providers, even individuals creating a program, all types of the primary media content provider.

Provider Partner 2120: The radio program provider, the media service provider, any type of radio station, radio network, national radio system, or web based media provider, even including individuals, who offer their individual show directly through the web, using e.g. web cameras, microphones and other studio-type equipment, all types of interactive program providers.

Carrier Partner 2130: The carrier, the mobile phone company, the provider of any types of wireless communication network, including blackberries, radiotelephones, network provider, any type of network provider.

Service Partner 2140: any entity which provides the interactive media service itself, in cooperation with the above partners. This company may provide the actual software to enable the operation of the interactive media system. This service can be active, i.e. actual participation by the service partner 2140 in the operations of the other partners 2100. Or it can be the enabling type, including providing originating/sourcing software to the source partner 2110 and corresponding enabling software to the carrier partner on any handset platforms, which include Java, BREW, and Windows Mobile. The software/code can be an executable or any other level of coding.

While in some embodiments the operator of the primary media content also operates and originates the interactive aspects of the interactive media service, as described in relation to FIGS. 3-8, in other embodiments the source partner 2110 provides a primary media content, which does not have an interactive component. E.g. the talk show host does not operate a stream editor, including a secondary content organizing panel 810. In these enibodiments the service partner 2140, or in some cases the provider partner 2120, can generate the interactive aspects of the media service. For example, service partner 2140 can mobilecast screenshots of the covers of a band's CD and offer them for sale in association with an interview with a band, which is received as audio-only from a radio station. Service partner 2140 can then facilitate the purchase of the advertised CDs and other m-commerce functionalities of the interactive media system.

Business Partner 2150: an entity which carries out some of the business related elements, including the actual purchase of an asset, e.g. by organizing the delivery of a static asset from a warehouse in relation to charging a credit card account, or authorizing the download of a ring tone from an corresponding server after charging the telephone account of a user. The business partner can operate “on-deck”, i.e. within the interactive media providers, or “off-deck”, i.e. by directing purchases to a company web-site. The business partner may include billing services providers, aggregators, and credit card processors.

In the following various business models 2200 will be described in relation to the revenue generating services 2000 and the media partners 2100.

Examples of business models 2200, which are indicative of the actual source of the revenues, include the following.

Subscriber model 2210: This system can be based on the subscription by the individual users 2211-1 . . . n to this interactive media service. In this subscriber model 2210 end users 2211 pay for receiving this service. The payment can be on a weekly or monthly or any other periodic basis, or even case-by case basis, including one time arrangements. It can be on an item-by-item basis, e.g. every time the user 2211 uses, or logs into the service, or every time the user 2211 makes an actual purchase. It can be prepaid before receiving the service, or postpaid after receiving the service. The user service can be on various levels, such as only SMS service or the possibility to call in to the talk show. The user service can include a purchasing application (such as a connection to the user's credit card, or phone bill), or just as a platform for receiving advertisements and interact with the studio.

Sponsor model 2220: This system can be based on the sponsorship by various sponsors 2221 which may have an interest in relation to this interactive media service. These sponsors 2221 may include the publisher of a new CD, a concert promoter, a book publisher, or a game software creator. They may chose to sponsor a talk show, where a star of the upcoming concert is interviewed by a DJ, or the voice of one of the characters in the video game chats with the talk show host. Here the source of the revenue may be the sponsor itself, such as the concert promoter sponsoring a half an hour long talk show with a star personality.

Advertiser model 2230: This system can be based on advertisers 2231, who want certain products be featured in relation to a radio program. These advertisers 2231 may pay in relation to specific advertisements, such as the featuring of a CD cover as secondary media content during a talk show with the artist. Here the source of the revenue may be the actual users who purchase the offered products, or the advertiser 2231, who pays according to the number of ad placements.

Revenue sharing model 2240: This system refers to the fact that once the revenues enter the interactive media service system, they are to be distributed according to internal agreements. Thus, revenue generated from a sponsor 2221 and received by the business partner 2150 will be subsequently channeled to the other media partners, such as the service partner 2140 or provider partner 2120. This shared revenue constitutes a business model for the media partners 2100 who do not collect the revenues themselves directly.

Sometimes one of the partners may wish to promote its services and thus may become a source of revenue for the other partners. For example, a new carrier partner 2130 may wish to promote its own brand in relation to a particular primary media content. In an example, a carrier partner 2130, such as a new mobile phone company may sponsor a radio sports show where its own phone services are prominently featured. This mobile phone company then may originate revenue for the other partners.

In other embodiments, as the content stream and the interactive transactions progress through the system from partner to partner, a mutual charging scheme can be implemented, where the media partners settle with the other partners individually, with whom they are in direct contact during the streaming and interactions.

In many of the business models, service partner 2140, who may actively operate the interactive media software, is well suited to keep track the revenue streams and facilitate their distributions to other partners. Service partner 2140 may also generate revenues by licensing the software to the other partners. In some embodiments, service partner 2140 may provide non-exclusive licenses to its partners, and also sell the software e.g. to individual source providers. Service provider 2140 may also provide the software on an “on-deck” or “off-deck” subscription basis to the other partners 2100. Such individual providers may even include individual persons who run their own show and distribute it through the Internet as a network, or local/municipal studios with limited reach, who may wish to use this service e.g. to vote on municipal issues. In some embodiments, other partners may take on some of these roles. Some embodiments may include a “title sponsorship” as well. This embodiment includes a sponsor sponsoring the interactive media service of the service partner 2140 itself, either in audio or video format, instead of any particular asset.

In each case there are various ways, or metrics 2300, to keep track of, or account for, the revenues. These metrics include:

Time metrics 2310: keeping track of the airtime, the number of minutes a guest is on the show, possibly including the repeat broadcasts. Any one of the partners 2100 can keep track of this metric, and then organize the revenue distribution accordingly. For example, source partner 2110 or provider partner 2120 can record the time metrics 2310 during a sale service 2010, and organize the corresponding revenue calculation and distribution among the partners 2100 according to the subscriber model 2210. This can include organizing the collection of the percentage of subscriber fees which correspond to the measured airtime, and distributing those fees among the partners 2100.

Usage metrics 2320: keeping track of the minutes the end users were actually listening to the show, even if they did not make purchases during the show. In this case e.g. carrier partner 2130 can track the usage time of the individual users though their wireless device during a community service 2040 (e.g. a participation in a moderated chat-room), such as mobile phone, and report the number of active user-minutes to a sponsor 2221 within the sponsorship model 2220. The sponsor 2221 then originates revenue for partners 2100. Or the carrier partner 2130 can directly charge the individual users 2211 according to the usage minutes during an auction of a responsive service 2030 (e.g. a participation in an auction) within the subscriber model 2210. Or a business partner 2150 can keep track of purchasing times of users in cooperation with a carrier partner 2130 within a targeted service 2050, and report the purchasing times to a sponsor 2221 within a sponsorship model 2220.

Event metrics 2330: keeping track of number “on-air mentions” or advertisements. This event metrics 2320 can be based on how many times the host mentioned the name of a product or asset, or how many times an ad was displayed as a secondary content on the display of the wireless devices. Again, any one of the partners 2100 can keep track of this metric, and then organize the revenue distribution accordingly. For example, source partner 2110 or provider partner 2120 can record the number of mentions of the concert within an advertisement service 2020 and report to an advertiser 2231 to obtain revenue within an advertising model 2230.

Revenue metrics 2340: keeping track of actual revenue, transactions, or downloads, generated during the show, possibly including a time period after the show ended. The revenue generation can be any one of the above revenue generating services 2000. For example, business partner 2150 can track downloads of screensavers during a talk show, and then organize the distribution of the revenues according to the sponsorship model 2220.

Importantly, embodiments include each and every combination of any of the revenue generating services 2000, provided by any of the media partners 2100, where the revenue can originate from any of the business models 2200, the revenues being tracked by any of the metrics 2300. The number of these combinations is vast, and may contain individually tailored aspects, which are all within the scope of the embodiments.

The implementation of these combinations can be unique and novel on their own right. Examples include that an interactive radio program directs users to subscribe to an on-line gaming service. This is an example of an “off-deck” revenue originating at a business partner 2150 during an advertisement service 2020. Business partner 2150 then can measure the revenue by any one of the metrics, such as usage metrics 2320 (if the gamer pays by the minute of use), or revenue metrics 2340 (if the gamer pays a monthly membership fee), and then distribute the revenues to the other partners, such as e.g. to the service partner 2140 through the revenue sharing business model 2240.

Another example includes “on deck” subscription revenues. A participating carrier partner 2130 may subscribe for the interactive media services of service partner 2140, which may include sale service 2010 in relation to particular radio programs. In a revenue sharing business model 2240 service partner 2140 may share its subscription revenues with source partner 2110 (e.g. the radio program originator) based on a usage metrics 2340, i.e. for how long time intervals did the participating carrier partner 2130 carry the radio program of the program originator. In a concrete example, a local radio station may have one popular interactive radio program, which gained nationwide following. A mobile phone carrier may subscribe to the services of a particular service partner only for the duration of these one-hour-a-day programs, and pay accordingly. During this program the CDs of previous broadcasts are offered for sale, which are purchased by listeners. The subscription revenue, tracked by the usage metrics 2320, and the transaction revenue, tracked by the revenue metrics 2340 is then shared by the service partner 2140 with the originator 2110 of the popular radio program within a revenue sharing model 2240. In some embodiments, this subscription revenue may be the “off-deck” type.

While various embodiments of the invention have been shown and described for purposes of illustration, it will be apparent to those of ordinary skill in the art that numerous alterations and variations may be made without departing from the scope of the invention or inventive concepts presented herein. For example, any combination of the described implementations and inclusion of their numerous equivalents also belong to the scope of the invention. The described methods, or portions of them, can be implemented in software, hardware, or in a combination of software and hardware. Steps in the described methods can be performed in different order and still provide desirable results. Persons of ordinary skill will appreciate that changes can be made to inputs, factors, combinations of factors, relationships of and between components, and other commercial or industrial techniques, all without departing from the scope of the invention. Also, those of ordinary skill will understand that the various steps, acts, methods, and sub-steps described with respect to alternate embodiments may be rearranged, substituted, or combined with each other and that various method steps and sub-steps described above with respect to alternate embodiments may be rearranged, substituted, or combined with each other, all without departing from the scope of the invention. Thus, the invention is not to be limited except in accordance with the following claims and their equivalents.

What is claimed is:

1. An interactive media service method, said method comprising:
providing partner services for a mobile-cast interactive media service;
providing revenue generating services in relation to the interactive media service; and
participating in a business model, including generating of the revenue and distributing of the revenue in relation to the interactive media service.

2. The method of claim 1, wherein the mobile-cast interactive media service comprises:
streaming media content towards users of the service on media channels; and
receiving interaction from the users over the same media channels.

3. The method of claim 1, wherein the mobile-cast interactive media service comprises:
streaming digital content directed to at least one mobile consumer device;
wherein the digital content comprises primary media content and secondary content;
receiving interactive communication initiated at the mobile consumer device, where the communication relates to the primary or secondary media content; and
at least one of initiating a transaction, modifying the primary media content, and modifying the secondary content in relation to the received interactive communication.

4. The method of claim 1, wherein the providing revenue generating services comprises:
providing a sale service by offering static or dynamic assets for sale in relation to the interactive media service; and
enabling a user of the interactive media service to initiate a transaction related to the asset offered for sale.

5. The method of claim 1, wherein
the static assets comprise durable goods; and
the dynamic assets comprise at least one of downloadable electronic goods, audio software products, video software products, games, ring-tones, electronic wallpapers, access to services, and screensavers.

6. The method of claim 1, wherein the providing revenue generating services comprises:
providing an advertisement service by mobile-casting an advertisement as a secondary media content in relation to a primary media content, wherein
the advertisement is one of a display of a static or dynamic asset on a wireless user device, and an on-air mention of an event; and
enabling the user to initiate a transaction related to the advertisement.

7. The method of claim 1, wherein the providing revenue generating services comprises:
providing a responsive service, including at least one of a survey, contest, polling, voting, betting, lottery, auction, and bidding,
wherein users of the media service are invited to respond to the responsive service through the same media channel used for a streaming of the interactive media service; and
facilitating a transaction by the user in relation to the responsive service.

8. The method of claim 1, wherein the providing revenue generating services comprises:
providing a community service, wherein the community service includes providing a moderated peer-to-peer community; and
facilitating user transactions in relation to the moderated peer-to-peer community.

9. The method of claim 1, wherein the providing revenue generating services comprises:
providing a targeting service, wherein the targeting service includes recording and reporting at least one of a purchasing profile of users of the service, a purchasing patterns of the users, a geographic distribution of the users, and a typical time of purchasing by the users.

10. The method of claim 1, wherein the providing revenue generating services comprises:
providing a tie-in service, wherein the tie-in service includes at least one of offering for sale an item in relation to previous activities of a user, and advertising products in relation to previous purchases of a user; and
facilitating a user transaction related to the tie-in service.

11. The method of claim 1, wherein the providing revenue generating services comprises:
providing in at least one of an on-deck service and an off deck service, wherein
the on-deck service includes facilitating user-initiated transactions in response to offers for sale through the channel used for the mobile-casting of the interactive media service; and
the off-deck service includes facilitating user-initiated transactions in response to offers for sale through channels different from the channel used for the interactive media service.

12. The method of claim 1, wherein the providing partner services for a mobile-cast interactive media service comprises:
providing source partner services for the interactive media services, including providing at least one of a primary media content, a radio program, a television program, a web-based program, and a secondary content.

13. The method of claim 1, wherein the providing partner services for a mobile-cast interactive media service comprises:
providing provider partner services for the interactive media services, including at least one of a streaming of a program, mobile-casting a program, broadcasting a program, and multi-casting a program.

14. The method of claim 1, wherein the providing partner services for a mobile-cast interactive media service comprises:
providing carrier partner services for the interactive media services, including at least one of providing a telephone network, a wireless telephone network, and a network for wireless devices for
mobile-casting a program towards at least one user; and
receiving and processing interactive user-initiated communications.

15. The method of claim 1, wherein the providing partner services for a mobile-cast interactive media service comprises:
providing service partner services for the interactive media services, including at least one of actively facilitating the interactive media service and providing a system for others to facilitate the interactive media service.

16. The method of claim 15, wherein the providing service partner services comprises:
providing a media management system for a source provider to facilitate source partner services for the interactive media services.

17. The method of claim 15, wherein the providing service partner services comprises:
operating an interactive program providing system, configured for receiving and managing user-initiated interactive communications or transactions.

18. The method of claim 15, wherein the providing service partner services comprises:
receiving a primary media content originated at a source service partner;
generating a secondary content associated with the primary media content, including at least one of a commercial content, a peer-to-peer content, and a participatory content; and
combining the primary media content and the generated secondary content into a content stream; and
streaming the combined content stream towards at least one user.

19. The method of claim 1, wherein the providing partner services for a mobile-cast interactive media service comprises:
providing business partner services for the interactive media services, including:
receiving a user-initiated communication from a partner service;
carry out a transaction related to the user-initiated communication.

20. The method of claim 19, wherein
the transaction is at least one of an on-deck and an off-deck transaction; and
the transaction is a purchase of a static or a dynamic asset.

21. The method of claim 1, wherein the participating in a business model, including generating revenue comprises:
participating in a subscriber model, including
generating revenues for the interactive media service from users paying subscriber fees, wherein the subscription can be on a periodic, or case-by-case, or transaction-by-transaction basis.

22. The method of claim 1, wherein the participating in a business model, including generating revenue comprises:
participating in a sponsor model, including
generating revenues for the interactive media service from a sponsor, by promoting the sponsor in the context of a primary media content.

23. The method of claim 1, wherein the participating in a business model, including generating revenue comprises:
participating in an advertiser model, including
generating revenues for the interactive media service from an advertiser, by
including advertisements into a secondary content of an interactive media stream.

24. The method of claim 1, wherein the participating in a business model, including generating revenue comprises:
participating in a revenue sharing model, including
sharing revenues with at least one partner within the interactive media service by a partner service provider who generated revenue in relation to the interactive media service.

25. The method of claim 1, wherein the participating in a business model, including generating revenue comprises:
facilitating the inclusion of secondary content into a primary media content by a service partner;
receiving and processing user-initiated interactive transactions; and
causing the collection of revenue in relation to the processed user-initiated transaction.

26. The method of claim 1, wherein the participating in a business model, including generating revenue comprises:
generating revenue according to a metric of the interactive media service.

27. The method of claim 26, wherein generating revenue according to a metric comprises:
generating revenue according to a time metric, including
keeping track of time a promotional item was incorporated in a primary media content or a secondary content; and
generating revenue according to the tracked time.

28. The method of claim 26, wherein generating revenue according to a metric comprises:
generating revenue according to a usage metric, including
keeping track of usage of the interactive media service by a user; and
generating revenue according to the tracked usage.

29. The method of claim 26, wherein generating revenue according to a metric comprises:
generating revenue according to an event metric, including
keeping track of events, including on-air mentions, advertisement placements in a primary media content or a secondary content; and
generating revenue according to the tracked events.

30. The method of claim 26, wherein generating revenue according to a metric comprises:
generating revenue according to a revenue metric, including
keeping track of revenues from transactions related to the interactive media service; and
generating revenue .according to the tracked revenue.
